(19) United States
(12) Patent Application Publication
(10) Pub. No.: US 2026/0059338 A1
(43) Pub. Date: Feb. 26, 2026

(54) SYSTEMS AND METHODS FOR PROTECTION AND OBFUSCATION OF INCUMBENT USERS ASSOCIATED WITH CITIZENS BROADBAND RADIO SERVICE (CBRS)

(71) Applicant: DISH Wireless L.L.C., Littleton, CO (US)

(72) Inventors: Khalid Al-Mufti, Sterling, VA (US); Zeev Render, Ashburn, VA (US); Hemant Mehta, Leesburg, VA (US)

(21) Appl. No.: 18/810,933

(22) Filed: Aug. 21, 2024

(51) Int. Cl. H04W 16/14; G01S 7/02; H04W 72/541; H04W 72/566

(52) U.S. Cl. CPC H04W 16/14; G01S 7/021; G01S 7/023; H04W 72/541; H04W 72/566

(57) ABSTRACT

Systems, devices, and methods related to citizens broadband radio service (CBRS) are provided. An example system includes multiple citizens broadband service devices (CBSDs) in a neighborhood proximate to a dynamic protection area (DPA) that includes multiple DPA tiles, a communication system installed on an incumbent user, and a centralized security system (CSS). The CSS can initiate a fallback sensing protection process in response to a determination that the incumbent user is disconnected from the CSS. The fallback process includes identifying CBSDs in the DPA based on the latest heartbeat message, causing each CBSD to continuously detect RADAR signals on an authorized channel, generating a move list indicating the CBSDs that interfere with the detected RADAR signals on the authorized channel, and transmitting the move list to the SAS. The SAS can cause the CBSDs to prevent interference with the incumbent user on the authorized channel.

### CROSS REFERENCE TO RELATED APPLICATIONS

The present application is related to U.S. Patent Application No. ______, titled “SYSTEMS AND METHODS FOR PROTECTION AND OBFUSCATION OF INCUMBENT USERS ASSOCIATED WITH CITIZENS BROADBAND RADIO SERVICE (CBRS)” and filed on Aug. 21, 2024, and U.S. patent application Ser. No. ______, titled “SYSTEMS AND METHODS FOR PROTECTION AND OBFUSCATION OF INCUMBENT USERS ASSOCIATED WITH CITIZENS BROADBAND RADIO SERVICE (CBRS)” and filed on Aug. 21, 2024, the disclosures of which are incorporated herein by references in their entirety.

### BACKGROUND

Citizens Broadband Radio Service (CBRS) systems utilize the 3.5 GHz frequency band (3550 MHz to 3700 MHz) to provide wireless services (e.g., 4G, 5G, etc.) to fixed or mobile devices in a geographic area. Since the 3.5 GHz band is shared between primary users (e.g., government or military users) and secondary users (e.g., commercial users), various protections are implemented to prevent the CBRS system from interfering with the operation of the primary users.

### SUMMARY

In accordance with some embodiments of the present disclosure, a system for citizens broadband radio service (CBRS) is provided. In one example, the system includes: multiple citizens broadband service devices (CBSDs) located in a neighborhood proximate to a dynamic protection area (DPA) that includes a plurality of DPA tiles, a communication system installed on an incumbent user associated with the CBRS, a centralized security system (CSS) connected to the communication system, and a spectrum access system (SAS). The communication system is operable and configured to generate a sequence of real-time heartbeat messages at a predetermined time interval. Each one of the heartbeat messages is time stamped and includes DPA data and radar activity data, the DPA data indicates the DPA tile in which the incumbent user is located, and the radar activity data indicates a radio channel on which an onboard radar of the incumbent user transmits radar signals. The communication system is further configured to transmit the sequence of real-time heartbeat messages to the CSS via a secure connection. The CSS is operable and configured to initiate a fallback sensing protection process in response to a determination that the incumbent user is disconnected from the CSS. The fallback sensing protection process includes identifying one or more CBSDs in the DPA, based on the latest heartbeat message received in the CSS, causing each CBSD to continuously detect RADAR signals on an authorized channel of the CBSD, generating a move list indicating the CBSDs determined to interfere with the detected RADAR signals on the authorized channel, and transmitting the move list to the SAS. The SAS is operable and configured to cause the CBSDs to prevent interference with the incumbent user on the authorized channel according to the move list.

In accordance with some embodiments of the present disclosure, an informing incumbent capability (IIC) system for CBRS is provided. In one example, an IIC system includes a CSS. The CSS includes one or more processors and a computer-readable storage media storing computer-executable instructions. The instructions when executed by the one or more processors cause the CSS to receive a plurality of heartbeat messages at a predetermined time interval. The heartbeat messages are transmitted from an incumbent user of a CBRS system through a secure connection. The CBRS system includes a plurality of CBSDs located in a neighborhood proximate to a DPA, and the DPA includes a plurality of DPA tiles. Each heartbeat message is time stamped and includes DPA data and radar activity data, the DPA data indicates the DPA tile in which the incumbent user is located, and the radar activity data indicates a radio channel on which an onboard radar of the incumbent user transmits radar signals. The instructions when executed by the one or more processors further cause the CSS to initiate a fallback sensing protection process in response to a determination that the incumbent user is disconnected from the CSS. The fallback sensing protection process includes identifying one or more CBSDs associated with the DPA, based on the latest heartbeat message received in the CSS, causing each CBSD to continuously detect RADAR signals on an authorized radio channel of the CBSD, generating a move list indicating the CBSDs determined to interfere with the detected RADAR signals on the authorized channel, and transmitting the move list to a spectrum access system (SAS). The SAS is configured to cause the CBSDs to prevent interference with the incumbent user on the authorized channel according to the move list.

In accordance with some embodiments of the present disclosure, a method for preventing interference with an incumbent user associated with a CBRS system is provided. The method may be a computer-implemented method. In one example, a CBRS system includes multiple CBSDs located in a neighborhood proximate to a DPA that includes multiple DPA tiles, a communication system installed on the incumbent user, a CSS connected to the communication system, and a SAS. The communication system is operable and configured to generate a sequence of real-time heartbeat messages at a predetermined time interval and transmit the sequence of heartbeat messages to the CSS via a secure connection. Each one of the heartbeat messages is timestamped and includes DPA data and radar activity data, the DPA data indicates the DPA tile corresponding to a current location of the incumbent user, and the radar activity data indicates a radio channel on which an onboard radar of the incumbent user transmits radar signals. The method includes initiating, by the CSS, a fallback sensing protection process in response to a determination that the incumbent user is disconnected from the CSS. The fallback sensing protection process includes identifying one or more CBSDs in the DPA, based on the latest heartbeat message received in the CSS, causing each one or the one or more CBSDs to continuously detect radar signals on an authorized channel of the CBSD, generating a move list indicating the CBSDs that interfere with the detected radar signals on the authorized channel, and transmitting the move list to the SAS. The method further includes causing, by the SAS, the CBSDs to prevent interference with the incumbent user on the authorized channel, according to the move list.

In accordance with some embodiments of the present disclosure, a computer device or computer system is provided. In one example, the computer device or computer system includes: one or more processors and a computer-readable storage media storing computer-executable instructions. The computer-executable instructions, when executed by the one or more processors, cause the computer device or computer system to perform a method described in the present disclosure.

In accordance with some embodiments, the present disclosure also provides a non-transitory machine-readable storage medium encoded with instructions, the instructions executable to cause one or more electronic processors of a computer system or computer device to perform any one of the methods described in the present disclosure.

### BRIEF DESCRIPTION OF THE DRAWINGS

FIG. 1A is a block diagram schematically illustrating one example of a CBRS system, according to various embodiments in the present disclosure.

FIG. 1B is a schematic diagram illustrating an example mechanism for the operation of the CBRS system of FIG. 1A, according to various embodiments in the present disclosure.

FIG. 1C is a schematic diagram illustrating a variation of the DPA shown in FIG. 1B, according to various embodiments in the present disclosure.

FIG. 2 is a message flow diagram illustrating the communication among various components of the CBRS system shown in FIG. 1A, according to various embodiments in the present disclosure.

FIG. 3A is a block diagram schematically illustrating another example of a CBRS system, according to various embodiments in the present disclosure.

FIG. 3B is a schematic diagram illustrating an example mechanism for the operation of the CBRS system shown in FIG. 3A, according to various embodiments in the present disclosure.

FIG. 4 is a message flow diagram illustrating the communication among various components of the CBRS system shown in FIG. 3A, according to various embodiments in the present disclosure.

FIG. 5 is a block diagram schematically illustrating another example of a CBRS system, according to various embodiments in the present disclosure.

FIG. 6 is a message flow diagram illustrating the communication among various components of the CBRS system shown in FIG. 5A, according to various embodiments in the present disclosure.

FIGS. 7-9 are flow diagrams respectively illustrating example methods for preventing interference with an incumbent user of a CBRS system, according to various embodiments in the present disclosure.

FIG. 10 is a block diagram illustrating an example computer system or computer device for implementation of the teachings described herein, according to various embodiments of the present disclosure.

### DETAILED DESCRIPTION

### Overview

A citizens broadband radio service (CBRS) includes incumbent users and secondary users such as Priority Access Licenses (PAL) users, General Authorized Access (GAA) users, and other secondary users of a shared spectrum. An incumbent user may also be referred to as an incumbent, a primary user, or an incumbent. In the hierarchy of shared spectrum access, incumbent users are at the top tier, followed by Priority Access Licenses (PAL) users, and then General Authorized Access (GAA) users. Incumbent users, such as Navy RADAR and Fixed Wireless Service satellite receivers have the highest spectrum access priority. Below the incumbent users, the priority access licenses (PALs) can use the spectrum allocated to incumbents as long as the aggregate interference from PAL users remains below the threshold for incumbent spectrum users. Similarly, GAA users can use the spectrum utilized by both incumbents and PAL users as long as the aggregate interference from GAA users remains below the thresholds for both incumbent and PAL users.

Such secondary users use CBRS device(s) (CBSD(s)). A CBSD is a radio including a transmitter coupled to an antenna. A CBRS system includes a spectrum access system (SAS) which regulates the transmissions of CBSD(s) in shared spectrum under the SAS's control, e.g., whether each CBSD of a SAS can transmit in the shared spectrum, and if so, then at what power level, to ensure that aggregate interference at incumbent users and other CBSDs is within appropriate limits. The SAS also may include a function to coordinate the shared spectrum usage among secondary users that are PLA and/or GAA CBSDs to diminish interference from GAA CBSDs to PAL CBSDs and between GAA CBSDs and to regulate interference from GAA CBSD(s) at certain location(s), e.g., geographic location(s) of incumbent user(s), of protection area(s), and of exclusion zone(s).

As an example, CBSDs of a CBRS may operate in a frequency spectrum which is sometimes, or dynamically, utilized by sea-based incumbent systems (e.g., government communications systems or military communications systems). An example of such incumbent user is a naval ship equipped with a ship borne RADAR. The naval ship may utilize RADAR proximate, e.g., 10 to 500 miles from shore. As a result, land based CBSDs may interfere with RADAR return signals by generating aggregate interference at or above a power spectral density threshold, e.g., −144 dBm/10 MHz for some ship borne RADAR. Different types of government communications systems can have different power spectral density thresholds. Incumbent systems, such as government communications systems, include at least one receiver, a transmitter and a receiver, and/or a transceiver.

The region in which such incumbent systems may be dynamically utilized is called a dynamic protection area (DPA). Each DPA may comprise a grid of points, e.g., separated by fifty meters, which are also known as protection points (PP). A DPA may have a large number of protection points.

Because operation of incumbent systems has priority over CBSDs, the SAS must ensure that when an incumbent system operates that the maximum aggregate interference generated by the CBSDs in a neighborhood of a DPA (where an operating incumbent system is located) is below the corresponding total transmission power threshold and/or the total power spectral density threshold. To do so, the SAS may operate to change, modify, or terminate operation, in the shared frequency spectrum, of one or more CBSDs that contribute to the aggregate interference at an incumbent user.

For example, the SAS may include a function to generate a move list (ML). A move list is a dynamic set of instructions to regulate the transmission activities of CBSDs operating in shared spectrum environments, particularly within the vicinity of DPAs where incumbent systems are operating. An example move list may include information about the identification of CBSDs whose transmissions are contributing to aggregate interference within the vicinity of a DPA where an incumbent system is operating, instructions specifying the action to be taken by each affected CBSD, such as adjusting transmission parameters (e.g., frequency, power level) or ceasing transmission altogether, parameters defining the changes required for transmission operations, including frequency bands to avoid, power levels to adjust, or time periods to suspend transmission, and timelines or activation schedules indicating when the instructed changes should take effect.

However, incumbent users (e.g., RADAR on naval ships) do not provide notification of operation to SAS. Typically, an environmental sensing capability (ESC) (or ESC system) may be deployed proximate to the DPA(s), where incumbent users may operate. The ESC system detects operation (e.g., transmission) of an incumbent user in a region within the DPA and communicates such operation of the incumbent user to the SAS. The ESC system may include one or more receiver systems or sensors distributed in or adjacent to the DPA(s). The receiver system(s) may be, for example, deployed by coastlines or shorelines to detect emissions from naval vessels in DPA(s).

Current CBRS systems and ESC systems face at least the following challenges identified in the present disclosure. First, during the operation and management of spectral resources for CBRS systems, it is sometimes important to obfuscate the location of the incumbent user operating in a DPA. For example, incumbent users in defense or military applications may require operational secrecy to maintain strategic advantages and protect against potential threats. Concealing the location of incumbent users also helps prevent intentional or unintentional interference from secondary users of the CBSDs. DPAs are currently designed to be large (e.g., ranging from tens to hundreds or thousands of kilometers in radius or diameter) in order to obfuscate the precise location of the incumbent user. In a particular example, incumbent users such as ships with shipborne RADAR may operate in dynamic environments where their positions can change over time. By establishing a large DPA, regulatory authorities and spectrum allocation managers can provide adequate protection/obfuscation for incumbent users regardless of their movements.

However, this approach also leads to overprotection of ship borne RADARs, as ESC systems are tasked with detecting RADAR activity across the entire outer edge of the DPA, which can extend up to 500 kilometers away from shoreline. This expansive coverage area can result in inefficiencies and excessive protection measures that are unnecessary. Moreover, the overprotection of ship borne RADARs within DPAs is at the expense of reduced spectrum efficiency for CBRS operations. ESC systems are required to detect RADAR activity within large DPAs, which may result in unnecessary restrictions on CBSD transmissions and decreased utilization of available spectrum resources. The large coverage area of DPAs and the associated move lists for changing/terminating CBSD transmissions can destabilize operators'frequency plans. Move lists, which are generated based on ESC detections of RADAR activity, may encompass a much larger area than necessary, which can result in the unnecessary change/termination of CBSD transmissions and disruptions to established frequency allocation plans.

Second, during the operation of the CBRS systems, operators of the CBSDs may not have visibility into the exact geographic locations of ESC sensors due to security measures implemented by ESC/SAS administrators. As a result, operators may lack information about how close their CBSD deployments are to ESC sensors, and it becomes difficult to assess the potential impact of their transmissions on ESC operations and determine appropriate transmit power levels.

In addition, CBSD operation must be limited or restricted in the area surrounding an ESC sensor. This area is sometimes referred to as a “whisper zone” surrounding the ESC sensor, because CBSDs operating within the whisper zone must transmit at lower power levels to minimize interference with the ESC sensor's detection capability. To minimize whisper zones and improve ESC effectiveness, ESC sensors are often deployed as close to the shore as possible. However, this can incur additional costs for tower leasing or building rooftop leasing, particularly in densely populated or geographically challenging areas. These costs can add significant financial burdens to ESC deployment and operation.

Moreover, ESC systems require backup power generation and redundancy measures to ensure continuous operation and avoid the activation of DPAs as fallback sensing protection mechanisms. Implementing backup power generators and redundancy features may increase the complexity and cost of ESC infrastructure, further strain resources, and affect the overall reliability.

Third, the obfuscation of incumbent user information may pose challenges to SAS and ESC. Without precise information about the location and activity of incumbent users, SAS relies on ESC sensors to scan and detect RADAR activities across all channels within the shared spectrum. This lack of specific information about incumbent users requires ESC sensors to continuously scan for RADAR activities, resulting in the collection of large volumes of data. Transmitting this data to the SAS for analysis consumes significant resources and can strain the processing capabilities of the system. Moreover, the SAS must then analyze this data to generate move lists and determine which CBSD transmissions need to be terminated or adjusted to avoid interference with incumbent users. This is less efficient due to the extensive resources required for data collection, transmission, and analysis. Additionally, the reliance on ESC sensors to detect RADAR activities across all channels introduces complexities and delays in spectrum management processes.

The present disclosure provides techniques to address at least the above-mentioned challenges. One insight provided in the present disclosure relates to an improved CBRS system having an informing incumbent capability (IIC) system and an SAS system. According to some embodiments, the IIC system includes a communication system installed on an incumbent user and a centralized security system connected to the communication system. The communication system is operable to periodically generate heartbeat messages and send the heartbeat messages to the centralized security system via a secured connection. Each heartbeat message is timestamped and includes encoded and encrypted, or ciphered DPA data, and RADAR activity data. The ciphered DPA data indicates the DPA tile in which the incumbent user is located; and the RADAR activity data indicates a radio channel on which an onboard RADAR of the incumbent user transmits RADAR signals. The centralized security system is operable to identify a region in a neighborhood proximate to the DPA based on the information provided in the heartbeat messages, determine one or more CBSDs in the region and authorized to operate on the radio channel indicated in the heartbeat message, generate a move list indicating the one or more CBSDs that are determined to interfere with the onboard RADAR of the incumbent user, and instruct the SAS to cause the one or more CBSDs to prevent interference with the incumbent user on the radio channel according to the move list.

The above CBRS system of the present disclosure provides at least the following advantages. First, it enables precise monitoring and management of spectrum usage while maintaining the obfuscation of incumbent user operations. By periodically transmitting heartbeat messages containing ciphered DPA data and RADAR activity data via a secured connection, the IIC system facilitates real-time detection of incumbent user activity, without exposing exact user locations to unauthorized parties. Second, by subdividing the larger DPA into smaller DPA tiles, each covering a smaller geographic area, the IIC system can localize protection efforts more precisely to ensure that only the specific areas where incumbent user activity is detected are subject to protection measures. Therefore, unnecessary restrictions on CBSD operations elsewhere within the DPA can be reduced, and overprotection of the incumbent user can be avoided. Third, the move lists can be generated and implemented with greater precision based on localized RADAR activity data. Generation of the move lists by the centralized security system operated by government authorities as opposed to the SAS further enhances the obfuscation of the incumbent user as the information used to generate the move lists is kept confidential within the secure environment of the IIC system. The present disclosure also provides variations of the CBRS system in alternative embodiments.

Another insight provided in the present disclosure relates to a fallback sensing protection mechanism that can be implemented by the present CBRS system. According to some embodiments, the centralized security system is further operable to activate a fallback sensing protection process in response to a determination that the incumbent user is disconnected from the centralized security system (e.g., in an event of no receipt of heartbeat messages as expected). An example of the fallback sensing protection process includes identifying one or more first CBSDs in the DPA based on the latest heartbeat message received in the centralized security system, causing each first CBSDs to continuously detect RADAR signals on an authorized channel of the CBSD, generating a move list indicating the first CBSDs determined to interfere with the detected RADAR signals on the authorized channel, and instructing the SAS to cause the first CBSDs to prevent interference with the incumbent user on the authorized channel according to the move list.

The fallback sensing protection mechanism provides an additional layer of protection for incumbent users within the CBRS system and allows for proactive monitoring and response to potential interference events, even in the absence of direct communication with the incumbent user. Additionally, by instructing the CBSDs to focus specifically on detecting RADAR activity on the authorized channel, rather than scanning across the entire spectrum, the CBSDs can effectively monitor for potential interference without expending resources on unnecessary tasks and provide more accurate and timely detection of potential interference events. Accordingly, the computation burden required to process RADAR activity data and generate move lists by the centralized security system can be significantly reduced.

### Example Systems, Devices, and Methods

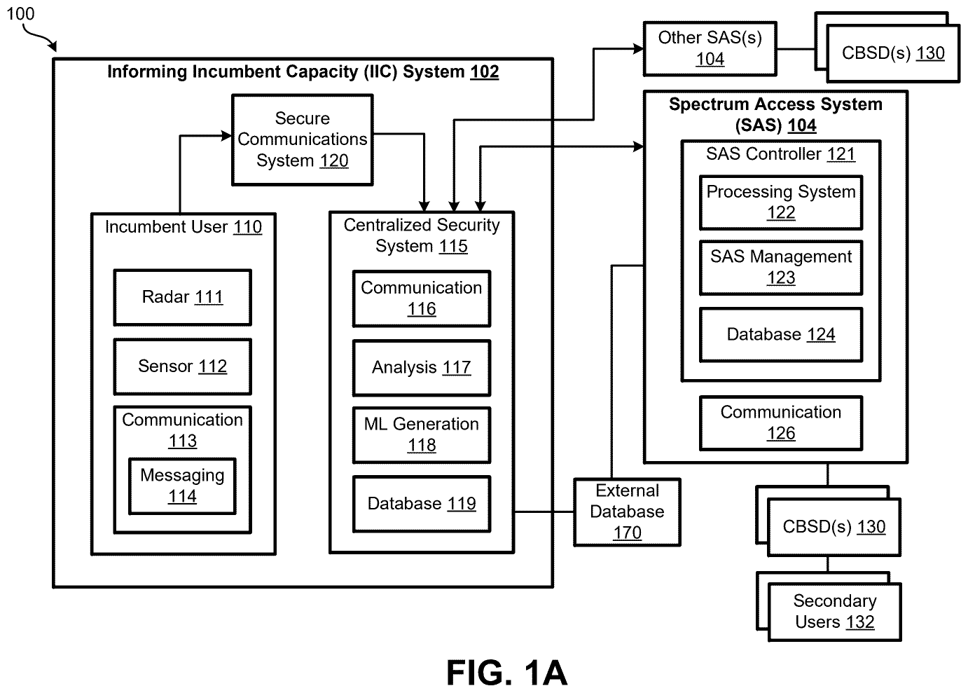

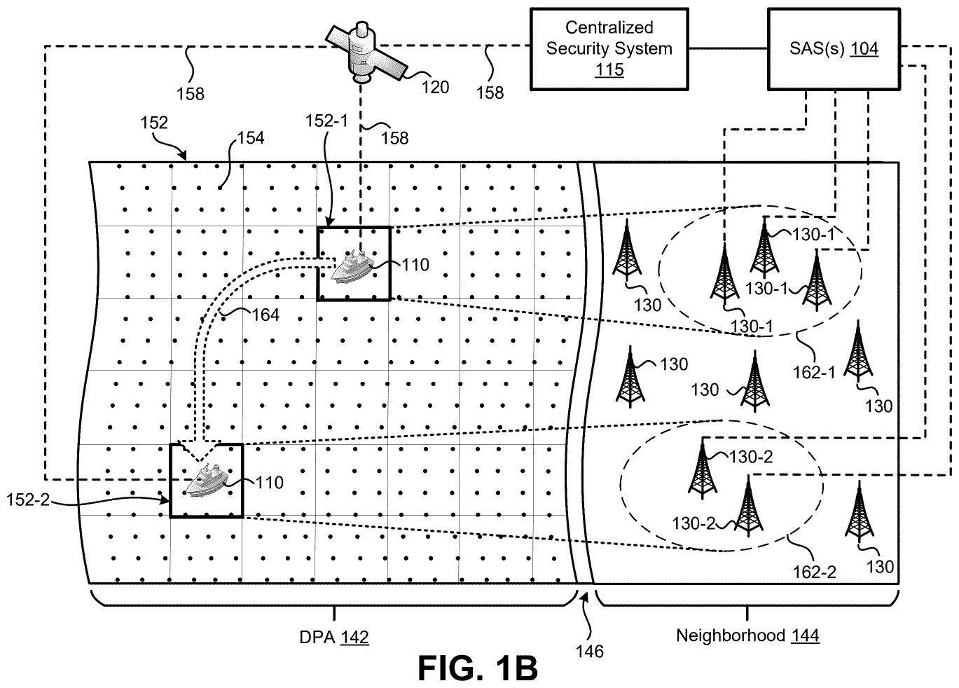

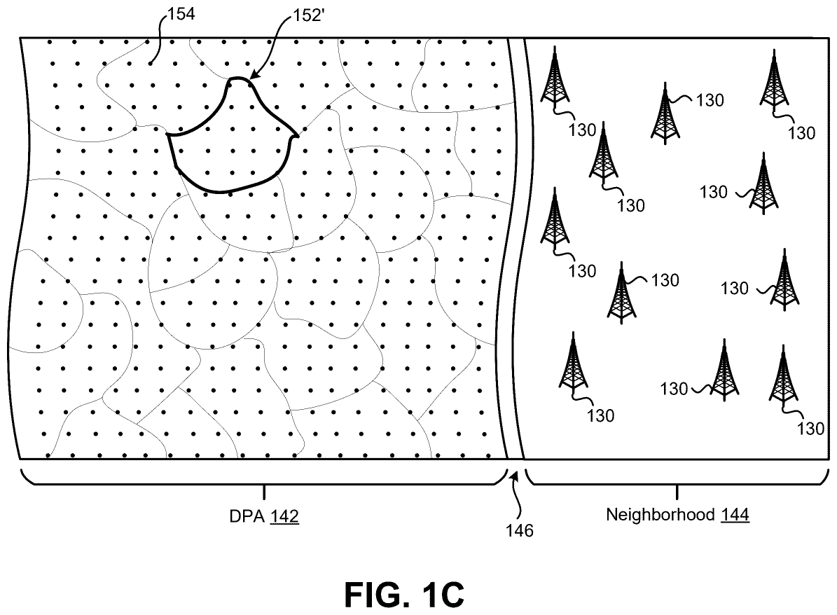

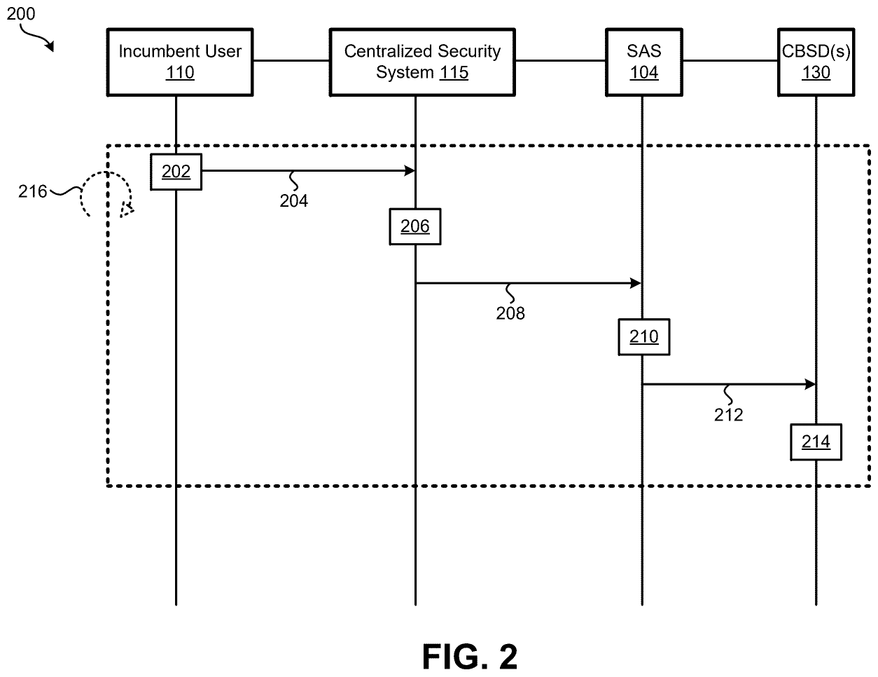

FIGS. 1A-1C and 2 illustrate an example of a CBRS system 100 (hereinafter “system 100”) and operations of the system 100, according to various embodiments in the present disclosure. FIG. 1A is a block diagram schematically illustrating one embodiment of the system 100. FIG. 1B is a schematic diagram illustrating an example mechanism for the operation of the system 100. FIG. 1C is schematic diagram illustrating a variation of the DPA 142 shown in FIG. 1B. FIG. 2 is a message flow diagram illustrating the communication of messages among various components of the system 100.

As illustrated in FIGS. 1A-1C, system 100 may be a CBRS system established to enable shared access to the 3.5 GHz band (3550-3700 MHz) of radio spectrum. System 100 can support various wireless communication services and applications, including mobile broadband, IoT (Internet of Things), fixed wireless access, and private wireless networks. In some embodiments, system 100 includes, among other components, an informing incumbent capability (IIC) system 102 (hereinafter “IIC system 102”), a spectrum access system (SAS) 104 (hereinafter “SAS 104”) in communication with the IIC system 102, and one or more CBSDs 130 communicatively connected to and controlled by the SAS 104.

At a high level, the IIC system 102 is operable to monitor and track the location and RADAR activity of an incumbent user in a DPA, secure the location and status information of the incumbent user, identify the CBSDs in a neighborhood area proximate to the DPA that potentially interfere with the RADAR activity of the incumbent user, and generate a move list based on the identified CBSDs. The SAS 104 is operable in conjunction with the IIC system 102 to implement/execute the move list to cause the identified CBSDs to minimize or prevent interference with the RADAR activity of the incumbent user.

In the illustrated example of FIGS. 1A-1C, the IIC system 102 further includes, among other components, an incumbent user system 110 (hereinafter “incumbent user 110”), a centralized security system 115, and a secure communications system 120. The incumbent user 110 may be a naval ship traveling in sea water. The incumbent user 110 further includes an onboard RADAR 111 (e.g., a ship borne RADAR), an onboard sensor 112, and a communication system or device 113. The communication system or device 113 further includes a messaging module 114. The centralized security system 115 further includes, among other components, a communication system or device 116, an analysis module 117, a move list generation device or module 118, and a database 119. The secure communications system 120 may include one or more satellites that facilitate secure communication between the incumbent user 110 and the centralized security system 115 (e.g., transmission of secured messages). The SAS 104 further includes, among other components, SAS controller 121, user database 124, and communication system or device 126. The SAS controller 121 further includes processing system 122. Each component of the systems described herein may be a hardware component such as a receiver, an emitter, an antenna, a transmitter, a transceiver, a device, a server, a processor, etc., a software component such as an engine, a module, a program, a service, an application, a package, a cloud-based service or application, etc., or a combination of hardware and software components configured to perform the intended functions. Fewer or additional components may be included in system 100.

In one example, the incumbent user 110 is a naval ship, and the onboard RADAR 111 is installed on the naval ship. The onboard RADAR 111 operates on various radio channels of a shared spectrum, which means that the onboard RADAR 111 utilizes multiple frequencies within the allocated frequency band of the spectrum. In some embodiments, the onboard RADAR 111 may be a SPN-43 RADAR. RADAR may have a mechanically swept antenna with a main beam, e.g., azimuthally swept three hundred and sixty degrees, or a phased array antenna with one or more main beams electrically directed. The incumbent user 110 has higher priority of access to the channels of the spectrum over the secondary users.

As illustrated in FIG. 1B, the incumbent user 110 may travel in a DPA 142. The DPA 142 may encompass land and/or water. In some embodiments, the DPA 142 encompasses water (e.g., sea water) only. The geological dimension of the DPA 142 may be predetermined by the government to protect the incumbent user 110 and obfuscate the location of the incumbent user 110. The DPA 142 includes an array of protection points (PP) 154. Each PP is defined by a set of geographical coordinates or ranges of coordinates, typically latitude and longitude, and represents a specific location within the DPA 142. The array of PP may form a grid-like structure that covers the entire DPA 142 for comprehensive coverage and monitoring of incumbent user activity. The size of each PP 154 can range from several meters to tens or hundreds of meters, depending on the granularity required for interference monitoring and mitigation. For example, PPs 154 may be separated by 50 meters.

In some embodiments, the DPA 142 comprises or is divided into multiple DPA tiles 152. Each DPA tile 152 is assigned a predetermined geological dimension and size. For example, DPA tiles 152 may be defined with dimensions of 1-10 square kilometers, and therefore can include multiple PPs 154 therein. The DPA tiles shown in FIG. 1B are in regular shapes, such as square or rectangular. The DPA tiles 152 are smaller units or subdivisions within the larger DPA 142 but are larger than the PPs 154. The division of DPA 142 into DPA tiles 152 provides advantages. While DPA tiles 152 provide a broader overview of spectrum usage within designated areas, they offer less granularity compared to PPs 154. This reduction in granularity can be advantageous for obfuscation purposes, as it reduces the risk of disclosing the precise location information about the incumbent user as well as the risk of targeted interference or unauthorized access. Further, by tracking DPA tiles 152 rather than individual PPs 154, more robust security measures and access controls can be implemented at the broader geographical level. Managing spectrum allocation and interference mitigation at the level of DPA tiles 152 also provides operational efficiencies compared to PPs 154.

Preestablished DPA data indicating the information about the DPA tiles 152 may be stored securely in the database 119 of the centralized security system 115, and only authorized parties are allowed to access the database 119 or retrieve the DPA data from the database 119. The DPA data includes various attributes such as the unique DPA ID, the unique DPA tile ID, the unique PP IDs, the precise geographic coordinates defining the boundaries of the DPA tile 152, descriptive details outlining the characteristics and features of the respective DPA tile 152, and detailed descriptions of the PPs 154 located within each DPA tile 152. In some embodiments, the DPA data includes only DPA ID, DPA title ID, PP ID. In some embodiments, the DPA data does not include the geographic coordinates/location of the incumbent user.

In some embodiments, the DPA tiles may be arbitrarily shaped. An example of a DPA having arbitrarily shaped DPA tiles 152′ is illustrated in FIG. 1C. Unlike traditional square or rectangular-shaped tiles, arbitrarily shaped DPA tiles 152′ are characterized by irregular or non-standard boundaries. The irregular shaped DPA tiles introduce complexity and variability, making it difficult for unauthorized parties to discern the exact boundaries of the DPA tiles, thereby enhancing the effectiveness of obfuscation and adding an additional layer of protection. Regulatory authorities or spectrum administrators can also enhance the security of sensitive information related to the incumbent users'locations, because the DPA tile shapes, boundaries, and geographical dimensions are only known to the IIC system 102.

A neighborhood 144 is proximate to the DPA 142 separated by shoreline 146. CBSDs 130 are located in the neighborhood 144. The neighborhood 144 may be defined by a neighborhood distance, for example, three hundred kilometers, from the shoreline 146. The neighborhood 144 can be a fixed region, independent of distance from any DPA tiles 152 or 152′. The neighborhood 144 may encompass multiple regions 162 (e.g., 162-1, 162-2, etc.) as shown in FIG. 1B. One or more CBSDs 130 may be located in each region 162. For example, CBSDs 130-1 are located in region 162-1, CBSDs 130-2 are located in region 162-2, and so forth. The regions 162 are predetermined with defined geological boundaries. Each region 162 corresponds/correlates to a DPA tile 152 of the DPA 142 according to a predetermined correlation map between the regions 162 and the DPA tiles 152. The correlation map may be predetermined by regulatory authorities according to various factors such as the distance and geography between the DPA tile 152 and the region 162. The correlation map may be secured information that is only known to the IIC system 102 or the regulatory authorities. The CBSDs 130 located within the region 162 are suspicious of contributing to the interference with the RADAR activity of the onboard RADAR 111 of the incumbent user 110 in the DPA tile 152 corresponding to the region 162.

As illustrated in FIG. 1B, the onboard sensor 112 installed on the incumbent user 110, such as a naval ship, is configured to detect RADAR signals emitted by the onboard RADAR 111. The onboard sensor 112 can operate in real-time to capture and acquire data pertaining to RADAR activity as it occurs (i.e., RADAR activity data). The RADAR activity data may encompass various parameters and information related to the detected RADAR emissions such as the frequency or channel on which the onboard RADAR 111 is operating. The RADAR activity data may optionally include the intensity or power level of the RADAR signals, the direction from which the RADAR signals are detected, and other relevant timing or duration information regarding the RADAR activity. In some embodiments, the RADAR activity data only includes the frequency or channel on which the onboard RADAR 111 is operating.

One example of the onboard sensor 112 is a RADAR detection system configured to identify and analyze RADAR emissions within a certain frequency range. The RADAR detection system may include antennas, receivers, and signal processing units capable of detecting and interpreting RADAR signals. Another example of the onboard sensor 112 is a radio frequency (RF) sensor capable of scanning the radio spectrum to detect, capture, and analyze signals emitted by onboard RADAR 111 and to identify patterns indicative of RADAR activity. Yet another example of the onboard sensor 112 is an optical sensor system including cameras or infrared detectors to detect visual cues associated with the onboard RADAR 111, such as antenna movements or emissions visible in the infrared spectrum. The onboard sensor 112 may also be a combination of RADAR detection sensor, RF sensor, and optical sensor to maximize detection capabilities.

The communication system or device 113 is configured to facilitate communication (e.g., transmission of messages, signals, information, data, data packets, etc.) between the incumbent user 110 and the centralized security system 115 via the secure communications system 120 and through a secured connection. In some embodiments, the secure communications system 120 is a satellite, and the communication system or device 113 is a satellite communication terminal including antenna, transceiver, modem, network devices required to establish and maintain a secured connection with the satellite. The antenna is used for transmitting and receiving signals to and from the satellite, the transceiver is used to handle the modulation and demodulation of signals, the modem facilitates the encoding and decoding of data using desired satellite network protocols, and the network device is used for managing connections and establishing secure communication links with the satellite.

The communication system or device 113 further includes a messaging module 114.

The messaging module 114 is configured to generate heartbeat messages (also referred to as “status messages” or “update messages”) periodically or at regular time intervals. Each heartbeat message is timestamped with a current time when the heartbeat message is generated. The time interval may be predetermined and vary from once per 5 seconds to once per 5 hours, depending on the location of the incumbent user 110. For example, when the incumbent user 110 is within the DPA 142, heartbeat messages may be generated and transmitted at a higher frequency, such as once per one minute. When the incumbent user 110 is not within the DPA 142 (e.g., in a large area (LA) where no protection from radio interference is required), the heartbeat messages may be generated and transmitted at a lower frequency, such as once per one hour.

When the incumbent user 110 is within the DPA 142, each heartbeat message may include, among others, a ciphered unique user ID of the incumbent user 110, ciphered DPA data, and RADAR activity data. The ciphered DPA data includes the unique DPA ID of the DPA 142 and the unique DPA tile ID of the DPA tile 152 when the location of the incumbent user 110 is within the DPA tile 152. The ciphered DPA data may further include a unique PP ID of each one of the PPs 154 included in the DPA tile 152. The ciphered RADAR activity data indicates a current operating status of the onboard RADAR 111 (e.g., active or inactive), a unique channel ID of a radio channel on which the onboard RADAR 111 is operating/transmitting, a frequency range (e.g., in MHz) of the channel. The ciphered RADAR activity data may optionally include the transmission power (e.g., in decibel-milliwatts (dBm)), a pulse repetition frequency (PRF), a pulse width, a RADAR mode, antenna azimuth and elevation angles, and other relevant information. The channel IDs are predefined and assigned to the specific frequency ranges or spectrum bands for the corresponding radio channel. When the incumbent user 110 is not within the DPA 142, the heartbeat message may include the user ID and location data, and the RADAR activity data may not be included.

The messaging module 114 is further configured to secure the heartbeat messages. For example, the messaging module 114 may encrypt the heartbeat messages using pre-established encryption/decryption protocols exclusively known to the IIC system 102. The encrypted heartbeat messages can only be deciphered by authorized parties with access to the appropriate decryption protocols, such as the operators of the centralized security system 115. Examples of the encryption/decryption protocols include but are not limited to Advanced Encryption Standard (AES) algorithms, Rivest-Shamir-Adleman (RSA) protocols, Secure Hash Algorithm (SHA), Diffie-Hellman Key Exchange protocols, among others.

The communication system of device 113 may timely transmit the encrypted heartbeat messages to the secure communications system 120 through a secured connection 158. The secure communications system 120 forwards the encrypted heartbeat messages to the centralized security system 115 through the secured connection 158, as illustrated in FIG. 1B. An example method for establishing the secured connection 158 is through a SATCOM link, which utilizes satellite communication technology to transmit data securely over long distances. The communication system or device 116 of the centralized security system 115 may be a satellite terminal configured to receive the encrypted heartbeat messages sent from the incumbent user 110. The analysis module 117 of the centralized security system 115 may include one or more servers operable to decrypt the heartbeat messages using the preestablished decryption protocols, analyze the data carried in the heartbeat messages, and extract information from the heartbeat messages.

In one example, a key exchange process is used to securely transmit the heartbeat messages from the incumbent user 110 to the centralized security system 115. Both the incumbent user (sender) and the centralized security system (receiver) initialize a communication session and prepare for a key exchange process. Each party generates its own cryptographic key pair, which may involve generating a public-private key pair using an agreed-upon cryptography algorithm. Through the SATCOM link 158, the incumbent user 110 sends its public key to the centralized security system 115, and the centralized security system 115 sends its public key to the incumbent user 110. Both parties use the received public keys and their own private keys to compute a shared secret key, which is used for symmetric encryption and decryption of the heartbeat messages. The incumbent user 110 uses the shared secret key to encrypt the heartbeat message before transmitting it via the SATCOM link 158, such that only the centralized security system 115 can decrypt and access the heartbeat message. Upon receiving the encrypted heartbeat messages, the centralized security system 115 uses its private key and the incumbent user's public key to derive the same shared secret key, which is used to decrypt the heartbeat message and extract the heartbeat data. In some embodiments, the key exchange process may be combined with other security protocols to further enhance the protection of the heartbeat messages.

The move list generation device 118 may include one or more servers operable to generate a move list based on the DPA data and RADAR activity data of the incumbent user 110 extracted from the heartbeat messages. In one example, the move list generation device 118 utilizes both the DPA data and RADAR activity data to identify potentially affected regions 162 within the neighborhood 144. This involves correlating the identified region 162 with the specific DPA tile 152 referenced in the heartbeat message, by employing a predetermined correlation map stored in the database 119. By cross-referencing the DPA tile ID provided in the heartbeat message with the stored correlation map, the move list generation device 118 can precisely determine the geographical area associated with the reported DPA tile. This correlation process enables the system to effectively isolate and delineate the region 162 within the neighborhood 144 corresponding to the indicated DPA tile 152. Optionally, each DPA tile 152 may have a set of predefined PPs 154, known to the move list generation device 118, that are spaced evenly around the perimeter of the DPA tile 152 and an additional subset of PPs 154 randomly placed within the perimeter of the DPA tile 152, such that the move list is calculated to ensure the set of PPs 154 is protected from CBSD interference. In this case the region 162 is determined by the set of CBSDs that is within the DPA neighborhood distance (e.g., the distance is defined for each DPA by authorities such as National Telecommunications and Information Administration (NTIA) or Department of Defense (DoD) from the set of the PPs 154 of the DPA tile 152.

Once the region 162 is identified, the move list generation device 118 generates a list of CBSDs 130 that are located in the region 162. The move list is based on the latest CBSD data obtained from the external database 170. Each SAS 104 has the frequency assignment database (FAD) of CBSDs 130 it is managing, and each SAS 104 shares the information with the centralized security system 115, via an authorized and authenticated link, as recommended by Zero Trust Architecture. (https://nvlpubs.nist.gov/nistpubs/SpecialPublications/NIST.SP.800-207.pdf]. The CBSD data may be timely updated and stored in an external database 170 in communication with the centralized security system 115, which can access the latest CBSD data. By integration of data from multiple sources, the move list generation device 118 enables identification of CBSDs 130 that may need to adjust their transmissions on the channel of the onboard RADAR 111 so as to reduce/minimize/prevent interference with the incumbent user 110.

The move list generated by the move list generation device 118 may further include the channel ID of the channel, the frequency range of the channel and the aggregate interference power spectral density on the channel at the DPA tile 152, or optionally the subset of PPs 154 on the perimeter of the DPA tile 152 and subset of PPs 154 within the DPA tile 152. For example, after the termination of grants of CBSDs 130 on the channel where RADAR activity was indicated, the total aggregate interference power from remaining CBSDs not removed (on the keep list) will not exceed the interference protection threshold at the DPA tile 152, as defined by WInnForum requirements for DPA protection.

Optionally, the move list generation device 118 may calculate the move list one time based on the heartbeat message with the DPA tile ID but no RADAR activity indicated. The move list generation device 118 may calculate a move list on each possible RADAR channel (e.g. channels 1 to 10), where each RADAR channel is 10 MHz, and save or cache the resulting move list as well as the intermediate results such as the determined path loss values from the CBSDs 130 in the neighborhood 144 or region 162 corresponding to the DPA tile 152. The move list generation device 118 may use information included in the cached move list to calculate the move list when a heartbeat message does indicate the RADAR activity of the onboard RADAR 111. The move list generation device 118 may update or refresh the cached move list calculations whenever the CBSD information is updated in such a way that the CBSDs in regions 162 is changed by the addition or removal of CBSDs.

The aggregate interference power spectral density refers to the total power spectral density of interference signals generated by the secondary users operating within a specific channel for a CBSD 130 located in the region 162. The aggregate interference power spectral density can be expressed in decibels relative to a reference level (dBm/Hz), which measures for both the signal power and the spectral density distribution of interference signals across the frequency band. The threshold for aggregate interference power spectral density specifies the maximum allowable level of aggregate interference power spectral density caused/contributed by the secondary users of the CBSDs included in the move list.

The latest CBSD data from the FAD may indicate a predetermined resource sharing plan of the spectrum by the incumbent user 110 and secondary users 132. Based on the plan, the move list generation device 118 may determine the threshold for total transmission power for each CBSD and the threshold for aggregate interference power spectral density by the secondary users operating on the CBSDs, based on the predetermined regulatory requirements and guidelines applicable to spectrum sharing for the users of the CBSDs. The predetermined regulatory requirements and guidelines may be stored in the external database 170.

The external database 170 may further include without limitation: (a) databases, e.g., government databases (such as provided by the U.S. Federal Communications Commission), which store information about CBSD(s), priority access licensees (PALs), and/or incumbent users; and/or (b) databases, e.g., government databases (such as the U.S. Geological Survey), storing information about terrain and other obstructions (e.g. buildings) and geographic morphology. In some embodiments, external database 170 stores terrain information store elevation data and/or geographic morphology data. In some embodiments, external database 170 stores geodesic map data.

The centralized security system 115 may send the move list to the SAS(s) 104. In some embodiments, the CBSDs 130 located in the region 162 are controlled by multiple SASs 104, and the move list may be generated by considering the predetermined regulatory requirements and guidelines for spectrum sharing among the CBSDs 130 controlled by all the relevant SAS(s) 104, and the centralized security system 115 may send the move list to every SAS 104 for them to implement.

Notably, the move list does not disclose/expose the user ID as well as the location data of the incumbent user, thus the sensitive information about the incumbent user is obfuscated. Moreover, the communication within the system 100 only involves the transmission of the DPA ID or DPA tile ID to the centralized security system 115. In some embodiments, the PP IDs are not disclosed/exposed to the centralized security system 115. This allows for maintaining the concealment of the precise location of the incumbent user 110, which adds an additional layer of protection and can further enhance the overall obfuscation of the incumbent user's information and reduce potential security risks for unauthorized access to sensitive data.

The SAS controller 121 may execute/implement the move list to regulate the operation (e.g., power levels and frequencies of operation) of the CBSD(s) 130 associated with and controlled by the SAS 104 to allow the incumbent user 110 to operate free of interference. Thus, for example, the CBSD(s) in the move list have their ability to transmit in the shared frequency spectrum during operation of the incumbent user terminated, e.g., their transmission frequencies may be shifted to other frequencies outside of the shared frequency spectrum.

In some embodiments, the SAS controller 121 includes a processing system 122 coupled to the communication system 126. The processing system 122 controls the operation of CBSD(s) 130 associated with the SAS 104. The processing system 122 may also be referred to herein as processing circuitry. The communication system 126 facilitates communications between the SAS controller 121 and other systems or devices, e.g., CBSD(s) 130, external database(s) 170, and/or other SAS(s) 104. In some embodiment, the communication system 126 is a data modem implemented with modem circuitry.

The SAS controller 121 may further include a SAS management system 123 and a user database 124. The user database 124 includes information about geographic location, operating frequency spectrum, power output level of operation, modulation types, antenna radiation patterns, radiated power (or transmission) model(s), and/or maximum tolerable interference level threshold (e.g., threshold aggregate interference power spectral density by secondary users 132 of the CBSD 130 controlled by the SAS 104). In some embodiments, the SAS management system 123 one or more servers operable to execute the move list and allocate spectrum resources accordingly. The SAS management system 123 may determine and generate a new spectrum sharing plan based on the move list, send the new spectrum sharing plan to the CBSD(s) 130, and instruct the CBSD 130 operators to authorize/change/modify/terminate transmissions on the affected channel in the shared spectrum by the secondary users 132. Database as used herein means any data storage technique, including a conventional database, data files, and/or storage registers.

In one example, the SAS management system 123 may receive a request, from a secondary user 132 (e.g., a PAL user or a GAA user) for transmission on a channel with a transmission power level of one or more CBSD controlled by the SAS 104. The SAS management system 123 may analyze the request and determine if the requested channel is specified in the move list. In response to a determination that the requested channel is specified in the move list, the SAS management system 123 may further determine if the requested transmission power level causes the total transmission power level to exceed the threshold for the transmission power and/or if the aggregate interference power spectral density would exceed the threshold for aggregate interference power spectral density. The SAS management system 123 may instruct the CBSD operators to accept or reject the request from the secondary user based on the determination outcome, for the purpose of preventing interference with the incumbent user 110.

FIG. 2 illustrates an example of a message flow diagram 200 during operation of the example system 100 of FIGS. 1A-1B. The incumbent user 510 periodically generates (FUNCTION 202) encrypted heartbeat messages and transmits (TRANSMISSION 204) the encrypted heartbeat messages to the centralized security system 115 through a secured connection such as a SATCOM link. The heartbeat message includes a user ID of the incumbent user, a DPA tile ID of the DPA tile where incumbent user is currently located, and RADAR activity data associated with the onboard RADAR of the incumbent user. The RADAR activity data indicates the channel on which the onboard RADAR is transmitting RADAR signals. The centralized security system 115 decrypts the heartbeat message, extract the DPA tile ID and the RADAR activity from the heartbeat message, and generates (FUNCTION 206) a move list including CBSD(s) located in a neighborhood region corresponding to the DPA tile ID and controlled by the SAS(s) 104. The centralized security system 115 transmits (TRANSMISSION 208) the move list to the SAS(s) 104. The SAS(s) 104 executes the move list and generates (FUNCTION 210) a new spectrum sharing plan and transmits (TRANSMISSION 212) to the CBSD(s) 130 controlled by the SAS 104. The CBSD(s) 130 execute (FUNCTION 214) the new spectrum sharing plan and change/modify/terminate transmissions associated with secondary users on the channel. The operations 202-214 described in FIG. 2 may be repeated (LOOP 216) as the heartbeat messages are generated periodically, until the incumbent user ceases RADAR activity or leaves the DPA (e.g., moving into non-DPA or large area where no protection against radio interference is needed).

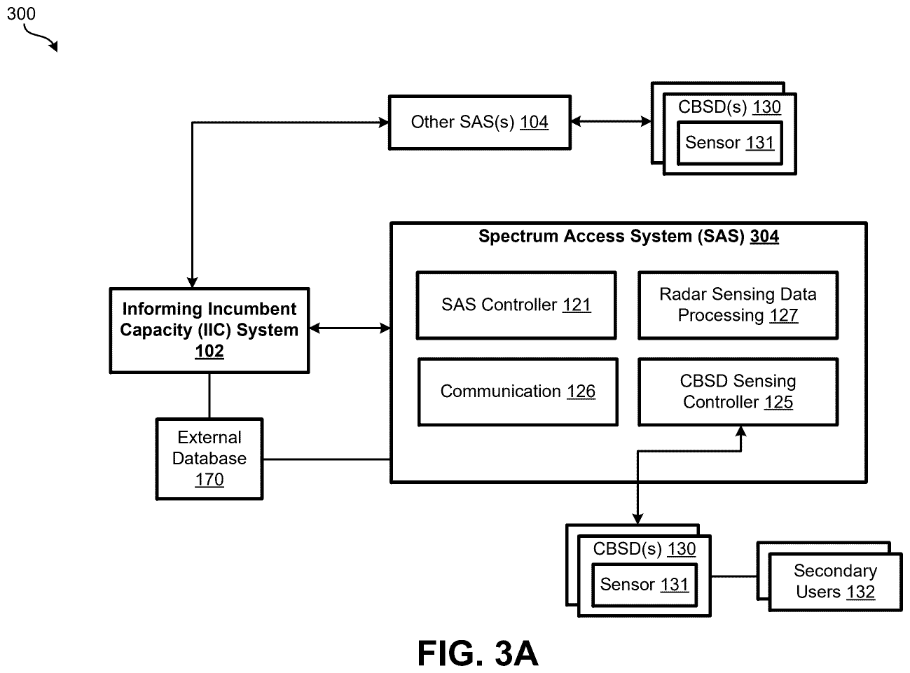

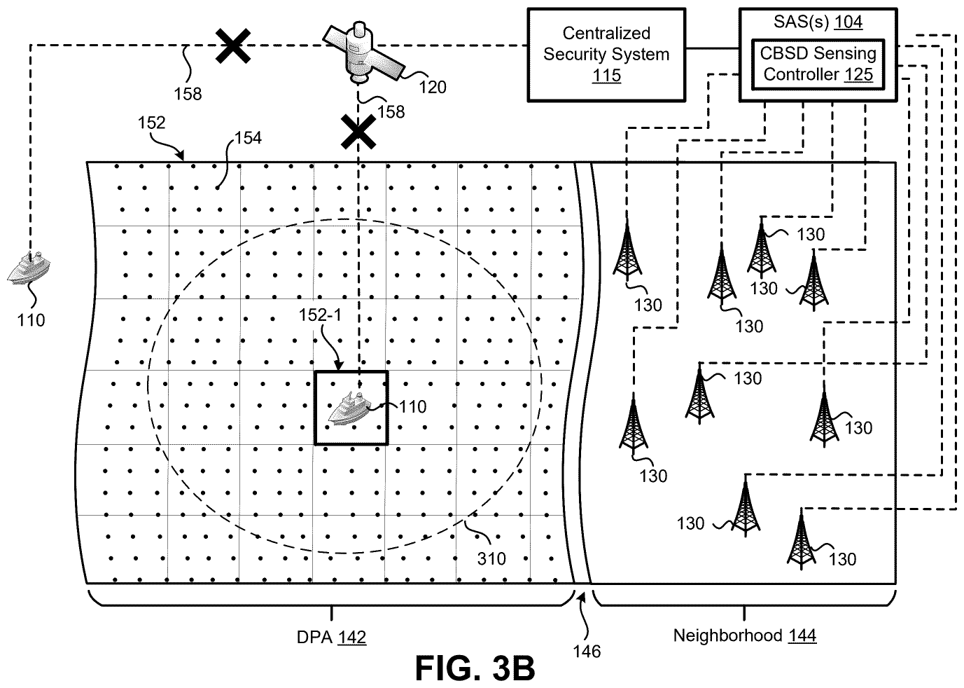

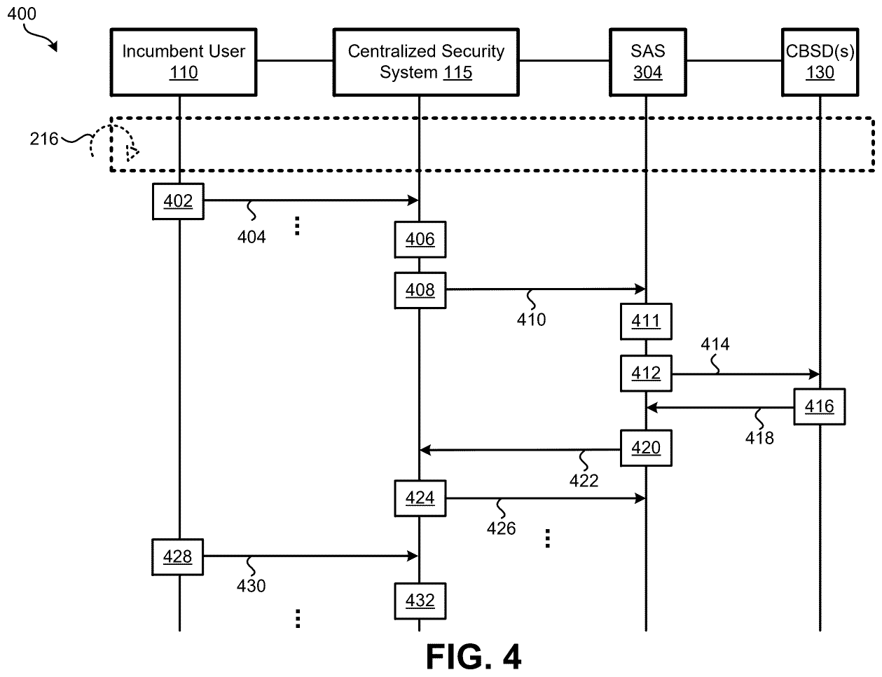

FIGS. 3A-3B and 4 illustrate another example of a CBRS system 300 (hereinafter “system 300”) and operations of the system 300, according to various embodiments in the present disclosure. FIG. 3A is a block diagram schematically illustrating one embodiment of the system 300. FIG. 3B is a schematic diagram illustrating an example mechanism for the operation of the system 300. FIG. 4 is a message flow diagram illustrating the communication of messages among various components of the system 300. System 300 is a variation of system 100 and may include various components of system 100. Similar components included in system 300 will not be repeated unless otherwise indicated.

In the example of FIGS. 3A-3B, system 300 includes, among others, the IIC system 102 of FIG. 1A, one or more SAS 304 in communication with the IIC system 102. The SAS 304 includes, among others, the SAS controller 121 and the communication system 126 of FIG. 1A. In addition, the SAS 304 further includes a CBSD sensing controller 125 and a RADAR sensing data processing system 127. One or more CBSDs 130 located in the neighborhood 144 proximate to the DPA 142 are associated with and controlled by each SAS 304 and in communication with the CBSD sensing controller 125 thereof. Each CBSD 130 further includes a RADAR sensor 131 operable to sense/detect RADAR signals transmitted on a specific channel of the shared spectrum.

At a high level, system 300 enables a fallback sensing protection mechanism in the event of a disconnection between the incumbent user 110 and the centralized security system 115, which may be signified by the absence of expected heartbeat messages to be received by the centralized security system 115. Upon activation of the fallback sensing protection mechanism, the SAS 304 assumes control over the CBSDs 130 associated with it. The CBSDs 130, under the control of the CBSD sensing controller 125, begin actively sensing RADAR signals on their authorized channel and generate RADAR sensing data. Subsequently, the centralized security system 115 utilizes the RADAR sensing data collected by the CBSDs 130 to generate a move list and outline necessary actions based on the detected RADAR signals. The fallback sensing protection mechanism enables continued monitoring and protection of the incumbent user, even in the absence of direct communication with the centralized security system 115.

As illustrated in FIG. 3B, the incumbent user 110 may be disconnected from the centralized security system 115 in some events, and this may happen either when the incumbent user 110 is outside of the DPA 142 or within the DPA 142. In normal situations, the incumbent user 110 keeps transmitting periodically heartbeat messages to the centralized security system 115, for example, at a preset frequency or time interval, and the centralized security system 115 expects to receive the heartbeat messages. However, when the incumbent user 110 is disconnected from the secure communications system 120, the centralized security system 115 does not receive heartbeat messages as expected, which may disrupt the monitoring and tracking of the incumbent user 110. The fallback sensing protection mechanism may be triggered to continue the protection of the incumbent user 110 in these situations.

In some embodiments, the centralized security system 115 employs a mechanism to assess the communication status of the incumbent user 110 with the IIC system 102. The centralized security system 115 continuously monitors the incoming heartbeat messages from the incumbent user 110 received at a predetermined time interval, typically corresponding to the expected frequency of heartbeat messages from the incumbent user 110. If no heartbeat message is received within the designated time interval after the latest received heartbeat message, the centralized security system 115 may detect a potential communication disruption. Based on the absence of expected heartbeat messages beyond the specified time duration (e.g., one or two times the normal interval), the centralized security system 115 determines that the incumbent user 110 user is disconnected from the centralized security system 115. Upon determining the disconnection, the centralized security system 115 may activate the fallback sensing protection process.

In some embodiments, when the latest heartbeat message indicates that the incumbent user 110 is located within the DPA 142 or a specific DPA tile 152, the centralized security system 115 employs an estimation process to determine the potential area within the DPA where the incumbent user 110 is likely to be located when it is disconnected from the centralized security system 115. Based on the latest location provided in the latest heartbeat message, the centralized security system 115 estimates a potential area within the DPA 142 where the incumbent user is likely to be present. This estimation may involve calculating a peripheral region 310 (also referred to as a “suspicious region 310”) centered around the latest location of the incumbent user, with the size of the region determined by various factors such as the duration of disconnection and the estimated speed of the incumbent user 110. Within the suspicious region 310, the centralized security system 115 identifies the DPA tiles 152 or PPs 154 that fall within or intersect with the suspicious region 310. The DPA tiles 152 are determined to potentially interfere with the RADAR activities of the incumbent user 110 when it is disconnected from the centralized security system 115.

In some embodiments, when it is difficult for the centralized security system 115 to accurately estimate the potentially impacted area within the DPA 142 (e.g., the suspicious region 310), the centralized security system 115 may determine that all CBSDs located in the neighborhood 144 potentially contribute to interference with the incumbent user 110.

In some embodiments, when the latest heartbeat message indicates that the incumbent user 110 is located outside of the DPA 142 (e.g., distanced far away from the boarder of the DPA 142), when the fallback sensing protection mechanism is activated, the centralized security system 115 may determine the potential DPA(s) 142 the incumbent user 110 may enter into, based on the estimated speed of the incumbent user 110, the moving direction of the incumbent user 110, or other factors. The centralized security system 115 may also estimate a timeframe for the incumbent user's entry into specific DPA(s) 142 by considering the distance between the user and the respective DPAs at the time of the latest heartbeat message.

In some embodiments, if the disconnected state of the incumbent user 110 persists beyond a predetermined threshold duration, the centralized security system 115 may determine that the disconnection is permanent and notify the regulatory authorities. Once the connection between the incumbent user 110 and the centralized security system 115 is restored (e.g., when the system begins receiving heartbeat messages again), the fallback sensing protection mechanism can be deactivated or terminated. Subsequently, the centralized security system 115 resumes its regular operations, including monitoring the incumbent user 110 and generating move lists as needed.

After the activation of the fallback sensing protection mechanism and the identification of potentially affected CBSDs 130 within the estimated suspicious region 310 or the entire DPA 142, the CBSD sensing controller 125 of the SAS 104 initiates communication with the identified CBSDs 130 and dispatch instructions to the potentially affected CBSDs 130 to direct them to commence RADAR activity sensing on the channels for which they are authorized to operate. The “authorized channel” here refers to the specific frequency bands or radio channels that the CBSDs are permitted to use for their transmissions according to regulatory permissions and spectrum management policies (e.g., specified in FAD database). Each CBSD is typically allocated a set of channels or frequency bands within the shared CBRS spectrum, and they are authorized to transmit within those allocated channels. The CBSDs 130 will detect/sense RADAR signals with predefined parameters such as pulse width, pulse repetition rates, etc., specified by organizations such as the National Telecommunications and Information Administration (NTIA) for ESC certification. Again, the sensing operation is limited to the frequency range or channel on which the CBSDs are authorized to transmit.

The CBSDs 130 send the RADAR sensing data to the SAS 304. The RADAR sensing data includes characterization of the RADAR signals detected by the CBSDs, such as the channel (frequency band), transmission power, power spectral density, pulse width, pulse repetition rate, etc. The RADAR sensing data processing system 127 is operable to collect, process, and analyze the received RADAR sensing data. For example, the RADAR sensing data processing system 127 determines if the detected RADAR signals are in a frequency band overlapping with the authorized channel of the CBSD. An overlap may indicate an interference by the CBSD with the incumbent user's RADAR activity on the authorized channel of the CBSD. In some embodiments, the RADAR sensing data processing system 127 compares the transmission power of the CBSDs on their authorized channels against a predetermined threshold. If the transmission power exceeds this threshold, it indicates that the CBSD is emitting signals at a level that may cause interference with the RADAR activity of the incumbent user. In some embodiments, the RADAR sensing data processing system 127 may similarly assesses the aggregate interference generated by multiple CBSDs operating on the same channel. The assessment may further involve calculating the aggregate interference power spectral density. If the calculated aggregate interference exceeds a predetermined threshold, it indicates that the collective interference from the CBSDs may interfere with the incumbent user's RADAR activity on the authorized channel.

Alternatively, the SAS 104 may send the RADAR sensing data collected from the CBSDs to the centralized security system 115, which may perform similar assessment to identify and determine a potential interference. The centralized security system 115 may generate a move list based on the RADAR sensing data. The move list may include the CBSDs identified to potentially interfere with the RADAR activity of the incumbent user during activation of the fallback sensing protection mechanism. The centralized security system 115 may send the move list back to the SAS(s) 104 and instruct the SAS(s) 104 to execute the move list and adjust spectrum allocation accordingly.

In one example, during activation of the fallback sensing protection mechanism for a DPA 142, a CBSD 130 that requests new channel grants overlapping with RADAR channels, such as those in the lower 100 MHz range, will not be immediately authorized to transmit on the requested channels. Instead, the SAS 104 will deny such requests until there is no RADAR activity sensed by the identified CBSDs 130 in the suspicious region 310 for a specified period, for example, 60 seconds. Once the CBSDs 130 do not detect any RADAR signals during this period, the SAS 104 may grant the channel requests. However, if RADAR signals are detected during this time frame, the SAS 104 will deny the grant requests, and the DPA 142 or the suspicious region 310 will be activated on that channel, which means that the CBSDs 130 will continue to sense the RADAR signals on their authorized channel. The activation will persist until a specified duration, such as 2 hours, elapses without any RADAR signals being sensed by any CBSD 130 in the neighborhood 144. This may further enhance the protection of the incumbent user 110 such that CBSD transmissions do not interfere with RADAR operations in the dynamic environments of spectrum sharing.

When the activation of RADAR sensing on the CBSD(s) 130 ends or no RADAR activity in DPA 142 is detected by the sensor of the CBSD(s) 130, the SAS 104 may send a clear message to the centralized security system 115. The clear message indicates that the protection measures previously activated for DPA tiles 152 in the DPA 142 or the suspicious region 310 can be lifted or deactivated. When the fallback sensing protection mechanism is active and the CBSD 130 stops sending RADAR sensing data, the SAS 104 may signal to the centralized security system 115 that the RADAR activity in the DPA 142 has ceased, and consequently, the protection measures can be cleared.

FIG. 4 illustrates the message flow diagram 400. After LOOP 216, the incumbent user 110 generates (FUNCTION 402) a latest heartbeat message and transmits (TRANSMISSION 404) the latest heartbeat message to the centralized security system 115. The centralized security system 115 determines (FUNCTION 406) that a predetermined time duration has elapsed since the latest heartbeat message and no further heartbeat message is received from the incumbent user 110. The centralized security system 115 activates (FUNCTION 408) the fallback sensing protection mechanism. The centralized security system 115 may determine a suspicious region 310 within the DPA 142 based on the location of the incumbent user from the latest heartbeat message, identify the DPA tiles 152 or PPs 154 that fall within or intersect with the suspicious region 310. The centralized security system 115 may send the information about the DPA 142, DPA tile 152, PPs 154, and suspicious region 310 to the SAS 304.

The SAS 304 may identify (FUNCTION 411) the CBSDs 130 correlating or corresponding to the DPA 142, DPA tile 152, PPs 154, or the suspicious region 310 in the neighborhood, based on the predetermined correlation map, generate (FUNCTION 412) an instruction for initiating the sensing mode of the identified CBSDs 130, and transmit (TRANSMISSION 414) the instruction to the identified CBSDs 130. The CBSDs 130 activate (FUNCTION 416) the sensing mode and begin detecting RADAR signals transmitting on the authorized channels. The CBSDs 130 transmits (TRANSMISSION 418) the RADAR sensing data to the SAS 304. The SAS 304 process the RADAR sensing data and calculate (FUNCTION 420) various parameters related to interference with the incumbent user 110. The SAS 304 transmits (TRANSMISSION 422) the RADAR sensing data to the centralized security system 115. The centralized security system 115 further processes the RADAR sensing data, determines the CBSDs 130 that potentially contributes to the interference with the incumbent user 110, and generates (FUNCTION 424) a move list including these CBSDs 130. The centralized security system 115 transmits (TRANSMISSION 426) the move list to the SAS 304 for execution. The incumbent user 110 restores (FUNCTION 428) generating heartbeat message and transmitting (TRANSMISSION 430) the heartbeat messages to the centralized security system 115 in a later time. When the centralized security system 115 begins receiving heartbeat messages as expected, it ceases or terminates (FUNCTION 432) the fallback sensing protection mechanism and causes the CBSDs 130 to stop sensing RADAR signals.

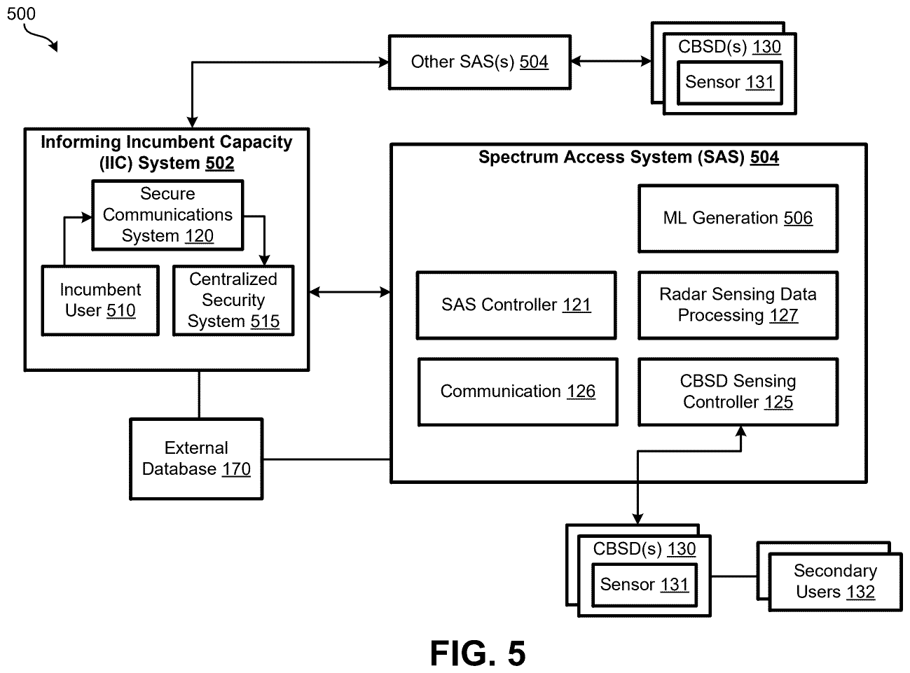

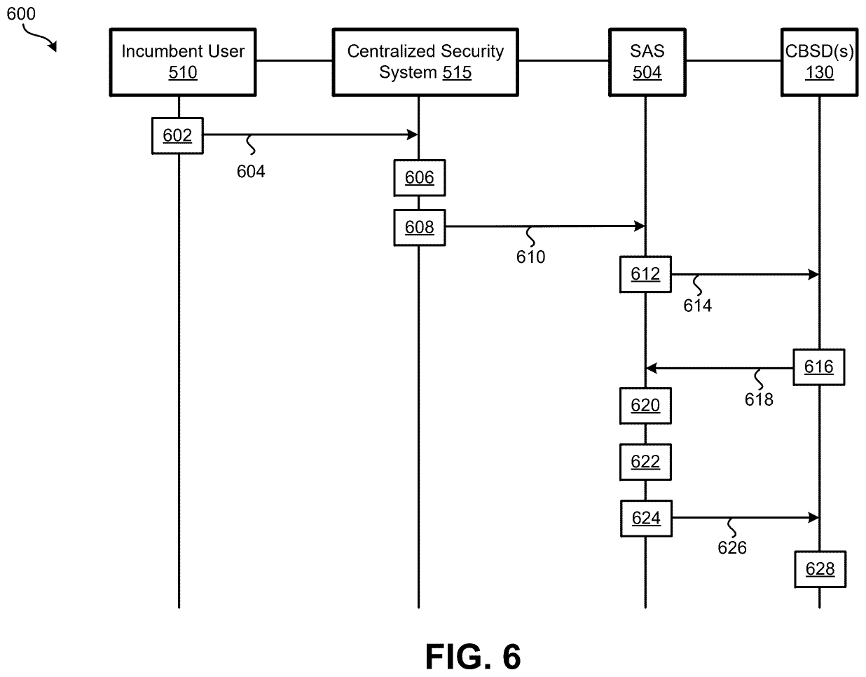

FIGS. 5-6 illustrate another example of a CBRS system 500 (hereinafter “system 500”) and operations of the system 500, according to various embodiments in the present disclosure. FIG. 5 is a block diagram schematically illustrating one embodiment of the system 500. FIG. 6 is a message flow diagram 600 illustrating the communication of messages among various components of the system 500. System 500 is a close variation of systems 100 and 300 and may include various components of systems 100 and 300. Similar components included in system 500 will not be repeated unless otherwise indicated. At a high level, system 500 leverages CBSDs located in the neighborhood to detect RADAR signals of the incumbent user as a routine operation, as opposed to the fallback sensing protection mechanism of system 300.

In the illustrated example of FIG. 5, system 500 includes IIC system 502, one or more SAS(s) 504, and CBSD(s) 130 associated with and controlled by the SAS(s) 504. The IIC system 502 includes an incumbent user 510 and a centralized security system 515. The IIC system 502 is a close variation of the IIC system 102, and the SAS 504 is a close variation of the SAS 101. Notably, the incumbent user 510 in the IIC system 502 may lack an onboard sensor for detecting RADAR activity, or the onboard sensor may not lack such capacity. Additionally, the centralized security system 515 may not include a move list generation device, which may instead be included within the SAS 504 (e.g., the move list generation device 506).

Similar to the system 100, during operation of the system 500, the incumbent user 510 generates heartbeat messages periodically, containing ciphered DPA ID, ciphered DPA tile ID, and/or ciphered PP ID. No RADAR activity data may be included. The incumbent user encrypts the heartbeat messages transmits them to the centralized security system 515 via a secure communications system 120. Upon receipt, the centralized security system 515 decrypts and analyzes the heartbeat messages, identifies CBSDs 130 in the neighborhood proximate to the DPA indicated by the heartbeat message, based on the predetermined correlation map between the DPA tile or the PPs and the CBSDs located in the neighborhood. If the heartbeat messages are not received by the centralized security system 515, then the SAS 504 will be informed by the centralized security system 515 to enable RADAR signal detection by CBSDs that are in the neighborhood of the last received DPA ID. In this case, the CBSD sensing controller 125 prompts these CBSDs 130 to detect RADAR signals on their authorized channels.

The CBSDs 130 detect/sense the RADAR signals, generates RADAR sensing data, and send the data to the SAS 504. Within SAS 504, the RADAR sensing data processing system 127 assesses potential interference scenarios between the incumbent user 510 and the CBSDs 130. Based on the assessment, the move list generation device 506 dynamically generates move lists. The SAS controller 121 may execute the move list and perform spectrum allocation adjustments as necessary to mitigate/prevent interference risks, in a similar manner as the operation of the systems 100 and 300. Optionally, the RADAR sensing data processing system 127 may send the RADAR detection information to the centralized security system 515, where the move list for the DPA 142 with missing heartbeat message(s) is calculated, and in response, the centralized security system 515 sends the move list to SAS 504 of CBSDs that must stop transmitting on the channel(s) where RADAR activity has been detected. CBSDs 130 that have been stops transmission due to the detected RADAR activity may continue to sense for RADAR activity on the channel(s) where RADAR activity has been detected until a period of time, e.g. 15 minutes, has elapsed with no RADAR activity detection, and in such case, a message can be sent to the SAS controller 121 indicating cessation of RADAR activity on such channel(s), and in turn, to the centralized security system 515. Until heartbeat message reception is restored, the centralized security system 515 can reinitiate the process of causing the CBSDs to sense RADAR activity for the impacted DPA, which it can determine based on the last received heartbeat message.

In some embodiments, the incumbent user 510 is disconnected from the centralized security system 515. During the disconnection, the centralized security system 515 may be operable to identify a suspicious region, based on the location data from the last received heartbeat message and/or the time duration of the disconnection. For example, the suspicious region may dynamically evolve and may be predicted or estimated based on the DPA tile indicated in the last received heartbeat message and the ongoing route of the incumbent user or the moving direction and speed, which are only known to the centralized security system 515. The CBSDs located in the suspicious region are caused to sense the RADAR signals and monitor for potential interference with the incumbent user. In this way, the CBSDs that are not located in the suspicious region may not sense the RADAR signals, which can reduce the burden of these CBSDs and improve the overall efficiency.

In the illustrated message diagram of FIG. 6, the incumbent user 510 periodically generates (FUNCTION 602) encrypted heartbeat messages and transmits (TRANSMISSION 604) the encrypted heartbeat messages to the centralized security system 515 through a secured connection such as a SATCOM link. Each heartbeat message includes a user ID of the incumbent user and a ciphered DPA ID of the DPA where the incumbent user 510 is currently located. In some embodiments, the heartbeat message further includes the ciphered DPA tile ID of the DPA tile in which the incumbent user is located. If there is no RADAR activity by the incumbent user 510, then no RADAR activity data is included in the heartbeat message. If incumbent user 510 is using the RADAR then the heartbeat message will contain RADAR activity data, e.g., the channel the RADAR is transmitting on. The centralized security system 515 decrypts the heartbeat message, extract the DPA tile ID from the heartbeat message, and if RADAR activity data is included in the heartbeat, identifies (FUNCTION 606) the CBSDs 130 that potentially interfere with the incumbent user 510 based on the DPA ID and/or the DPA tile ID included in the heartbeat message. The centralized security system 514 generates (FUNCTION 608) a notification indicating the identified CBSDs 130 associated with the current location of the incumbent user 510 and sends (TRANSMISSION 610) the notification to the SAS 504. When the heartbeat message includes RADAR activity data then the notification includes the list of identified CBSDs 130 and the channel that needs to be cleared. When the heartbeat message(s) is/are not received by centralized security system 515, then the notification is sent with a list of CBSDs, based on the last DPA ID in the last received heartbeat message from incumbent user 510, that need to start detecting/sensing RADAR activity (as in the fallback sensing protection process).

Upon receipt of the notification with a list of identified CBSDs that need to start sensing for RADAR activity (fallback processing case), the SAS 504 generates (FUNCTION 612) an instruction to instruct the identified CBSDs to begin detecting RADAR signals on their respective authorized channels and sends (TRANSMISSION 614) the instruction to each one of the identified CBSDs 130. Each one of the CBSDs 130 begins to detect RADAR signal on its authorized channel following the instruction, generates (FUNCTION 616) RADAR sensing data of the RADAR signals received in the CBSD 130, and transmits (TRANSMISSION 618) the RADAR sensing data to the SAS 504. The SAS 504 determines (FUNCTION 620) whether the CBSD 130 interferes with the received RADAR signal. The determination may be made based on the total transmission power and/or the aggregate interference power spectral density on the specific channel indicated in the RADAR sensing data as described above. The SAS 504 generates (FUNCTION 622) a move list including the CBSDs determined to interfere with the RADAR signal on the authorized channel of each CBSD. The SAS 504 executes (FUNCTION 624) the move list and generates a new/update spectrum sharing plan and transmit (TRANSMISSION 626) to the CBSDs that are determined to interfere with the detected RADAR signal. The CBSDs execute (FUNCTION 628) the new spectrum sharing plan and change/modify/terminate transmissions associated with secondary users.

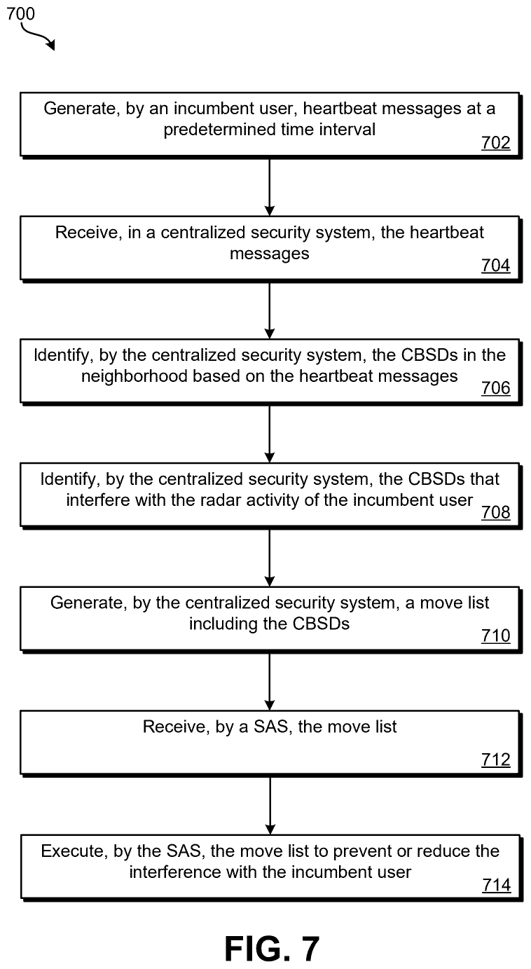

FIGS. 7-9 are flow diagrams illustrating example methods for managing spectral allocation, according to various embodiments of the present disclosure. The methods may be performed by the CBRS systems 100, 300, and 500 described herein. Few or additional operations may be included in each method. Operation(s) of one method may be combined with operation(s) of another method in a suitable manner.

FIG. 7 illustrates one embodiment of method 700 for preventing interference with an incumbent user and obfuscating the incumbent user within a CBRS system according to FIGS. 1A-1C and 2. The CBRS system includes an incumbent user, a centralized security system, a SAS, and one or more CBSDs associated with and controlled by the SAS. The CBSDs are located in a predetermined neighborhood area that is proximate to a predetermined DPA. The incumbent user has an onboard RADAR, an onboard sensor, and an onboard communication system. The onboard RADAR is operable to transmit RADAR signals on a channel of a shared spectrum provided by the CBRS system. The onboard sensor is operable to detect the RADAR signals transmitted by the onboard RADAR.

At 702, a plurality of heartbeat messages is generated at a predetermined time interval, by the incumbent user. Each heartbeat message is timestamped and includes user ID, ciphered real-time DPA data, and if RADAR is active, the ciphered real-time RADAR activity data. The ciphered DPA data includes a DPA ID of the DPA and a DPA tile ID of the DPA tile where the centralized security server knows how it is mapped to where the incumbent user is currently located. The ciphered RADAR activity data includes an operating status of the onboard RADAR (e.g., active or inactive), the channel ID of the radio channel on which the onboard RADAR is currently operating and frequency range. Optionally, the ciphered RADAR activity information may include transmission power, pulse repetition frequency, pulse width, among others.

At 704, the heartbeat messages are timely transmitted by the communication system to the centralized security system. In some embodiments, each heartbeat message may be encrypted by the communication system and transmitted to the centralized security system through a secured connection such as a SATCOM link. The heartbeat messages are received in the centralized security system and decrypted to extract the DPA data and RADAR activity data from the heartbeat messages.

At 706, one or more CBSDs located in the neighborhood are identified, by the centralized security system, based on the DPA data of the heartbeat messages. In some embodiments, the heartbeat messages are decrypted using a protocol only known to the incumbent user and the centralized security system. The DPA data and RADAR activity data are extracted from the heartbeat messages. A region within the neighborhood is identified based on a predetermined correlation map that specifies the correlation between the region and the DPA ID and the DPA tile ID included in the DPA data. The CBSDs located within the region are identified.

At 708, one or more CBSDs that contribute to the interference with the transmission of the onboard RADAR of the incumbent user are determined, by the centralized security system, based on the RADAR activity data. In some embodiments, the CBSDs that operate on the channel indicated by the RADAR activity data included in the heartbeat message are identified as contributing to the interference with the RADAR activity of the onboard RADAR on the channel. In some embodiments, a determination is made on whether the total transmission power of the CBSDs on the channel exceeds a predetermined threshold. If the total transmission power of the CBSDs on the channel exceeds the predetermined threshold, the CBSDs are determined to interfere with the incumbent user. In some embodiments, a determination is made on whether the aggregate interference power spectral density of the CBSDs operating on the channel exceeds a threshold. If the aggregate interference power spectral density of the CBSDs operating on the channel exceeds the threshold, the CBSDs are determined to contribute to interference with the incumbent user.

At 710, a move list is generated, by the centralized security system. The move list includes the CBSD IDs of the CBSDs that are determined to interfere with the incumbent user, the channel ID, and optionally the threshold for total transmission power on the channel, and the threshold of aggregate interference power spectral density on the channel, among others. The move list does not include the identity and location of the incumbent user for the purposes of obfuscating the incumbent user.

At 712, the move list is transmitted from the centralized security system to the SAS and received in the SAS. At 714, the move list is executed by the SAS to prevent or reduce the interference by the CBSDs with the incumbent user. The CBSDs may terminate transmission of signals on the channel by secondary users or reject a request for transmission of signals on the channel by a secondary user.

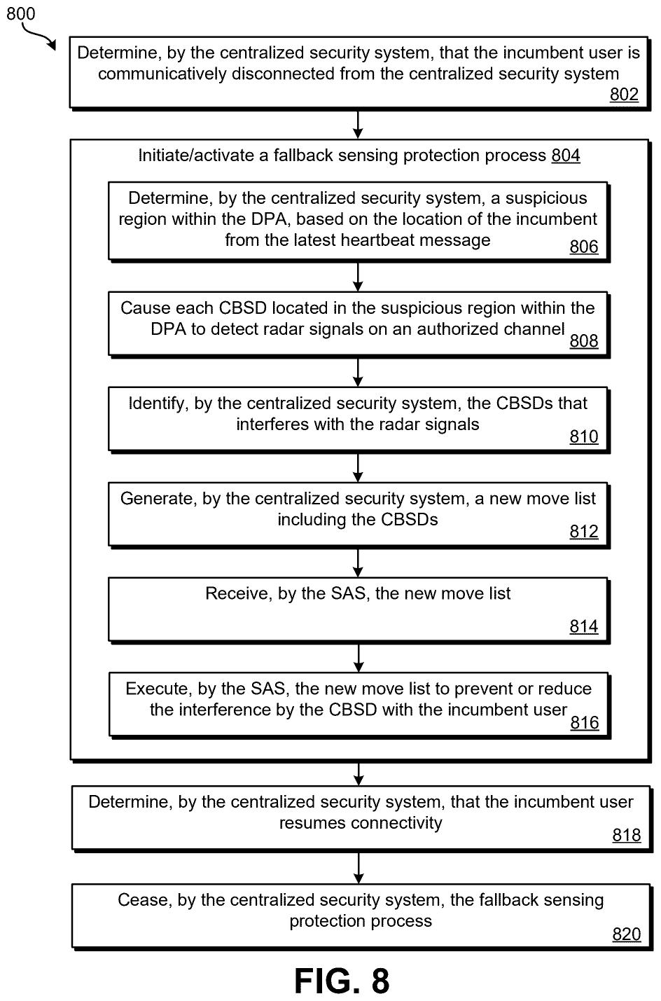

FIG. 8 illustrates one embodiment of method 800 for preventing interference with an incumbent user and obfuscating the incumbent user within a CBRS system according to FIGS. 3A-3B and 4. The method 800 provides an example of the fallback sensing protection mechanism.

At 802, a determination is made, by the centralized security system, that the incumbent user is communicatively disconnected from the centralized security system. In some embodiments, it is determined that a predetermined time duration has elapsed since the latest heartbeat message and that no further heartbeat message is received from the incumbent user thereafter.

At 804, a fallback sensing protection process is activated by the centralized security system in response to the disconnection. The fallback sensing protection process may further include operations 806-816.

At 806, a suspicious region within the DPA is determined, by the centralized security system, based on the location of the incumbent from the latest heartbeat message. The CBSDs located in the suspicious region are identified.

At 808, a notification indicating the suspicious region and the CBSDs located therein is transmitted from the centralized security system to the SAS. An instruction is transmitted from the SAS to each one of the CBSDs located in the suspicious region to cause the CBSDs to begin detecting RADAR signals on an authorized channel of the CBSDs that overlap the RADAR operating channels (e.g., lower 10 channels from 3550 MHz to 3700 MHz that are divided into 10 MHz segments) of the CBRS spectrum, and obtain real-time RADAR sensing data.

At 810, the detected RADAR sensing data is timely transmitted to the centralized security system, via the SAS. A determination is made on whether the CBSD interferes with the RADAR signals on the authorized channel, based on the channel ID of the authorized channel and the RADAR sensing data.

At 812, a new move list is generated by the centralized security system. The new move list includes the CBSD determined to interfere with the detected RADAR signals on the authorized channel. At 814, the new move list is sent from the centralized security system to the SAS. At 816, the new move list is executed by the SAS to cause each CBSD to prevent or reduce the interference with the detected RADAR signals on the authorized channel.

The fallback sensing protection process may continue (e.g., operations 804-816 may be repeated) until the recovery of the connectivity between the incumbent user and the centralized security system. Optionally, when CBSDs have been moved from a channel due to sensing RADAR while in the fallback sensing protection process, then such CBSDs will continue to sense on the channel where RADAR activity has been detected in order to determine that RADAR activity has ceased on that channel, which is indicated to the centralized security system where a decision can be made to restore the channel allocation of such CBSDs prior to the RADAR activity detection (during the fallback sensing protection process).

At 818, a determination is made that the incumbent user resumes connectivity with the centralized security system, for example, when the centralized security system begins receiving the heartbeat messages as expected. At 820, the fallback sensing protection process is ceased/terminated/deactivated by the centralized security system, and the centralized security system resumes the function of generating move lists based on the information included in the heartbeat messages.

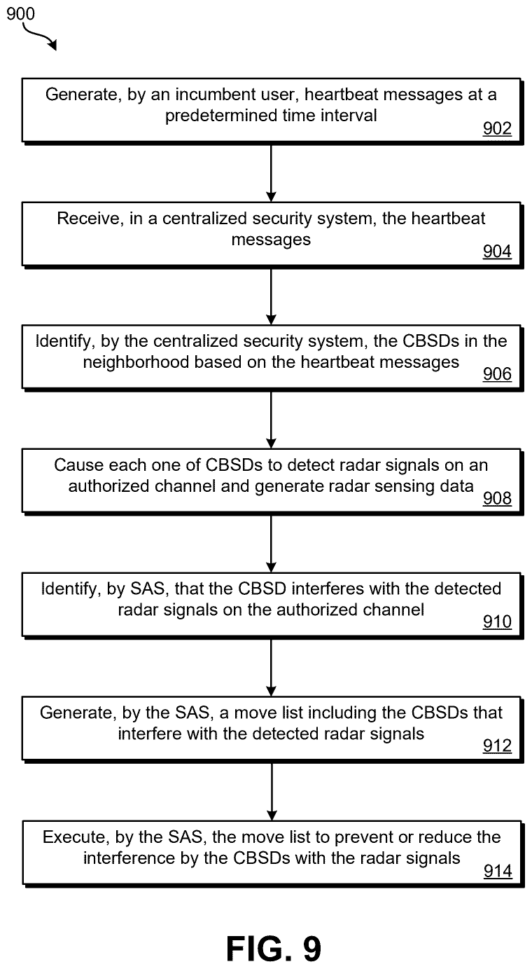

FIG. 9 illustrates one embodiment of method 900 for preventing interference with an incumbent user and obfuscating the incumbent user within the CBRS system according to FIGS. 5-6. The CBRS system includes an incumbent user, a centralized security system, a SAS, and one or more CBSDs associated with and controlled by the SAS. The CBSDs are located in a predetermined neighborhood area that is proximate to a predetermined DPA. The incumbent user has an onboard RADAR. The onboard RADAR is operable to transmit RADAR signals on a channel of a shared spectrum provided by the CBRS system. The incumbent user may not have an onboard sensor.

At 902, a plurality of heartbeat messages is generated at a predetermined time interval, by the incumbent user. Each heartbeat message is timestamped and includes a user ID and ciphered real-time DPA data. The heartbeat message may or may not include RADAR activity data of the onboard RADAR. The ciphered DPA data includes a DPA ID of the DPA and optionally a DPA tile ID of the DPA tile which the centralized security system can map to where the incumbent user is currently located.

At 904, the heartbeat messages are timely transmitted by a communication system of the incumbent user to a centralized security system. In some embodiments, each heartbeat message may be encrypted by the communication system and transmitted to the centralized security system through a secured connection such as a SATCOM link. The heartbeat messages are received in the centralized security system and decrypted to extract the DPA data, and thereby mapping DPA tile ID to the location of the incumbent user, from the heartbeat messages.

At 906, one or more CBSDs located in a neighborhood of the DPA are identified, by the centralized security system, based on the ciphered DPA data included in the last received heartbeat messages. A notification indicating the identified CBSDs is sent to a SAS in communication with the centralized security system.

At 908, each one of the identified CBSDs is caused to initiate detection of RADAR signals on an authorized channel of the CBSD (e.g., based on a predetermined spectrum sharing plan) and generate real-time RADAR sensing data. The RADAR sensing data is timely transmitted to the SAS. At 910, a determination is made on whether CBSD interferes with the detected RADAR signal on the authorized channel. As described above, the determination may be made based on whether the total transmission power exceeds a predetermined threshold level and/or whether the aggregate interference power spectral density exceeds a predetermined threshold level.

At 912, a move list is generated by the SAS. The move list includes the CBSDs determined to interfere with the RADAR signals on the authorized channel. At 914, the move list is executed by the SAS to prevent or reduce interference by the CBSDs with the detected RADAR signals.

Alternatively, the RADAR sensing data may be forwarded by the SAS to the centralized security system, and the centralized security system performs the identification/determination of CBSDs that interfere with the detected radar signals on the authorized channel, determination of the interference level (e.g., the total transmission power and aggregate interference power spectral density on the authorized channel), and generation of the move lists. The move lists are transmitted to the SAS for execution.

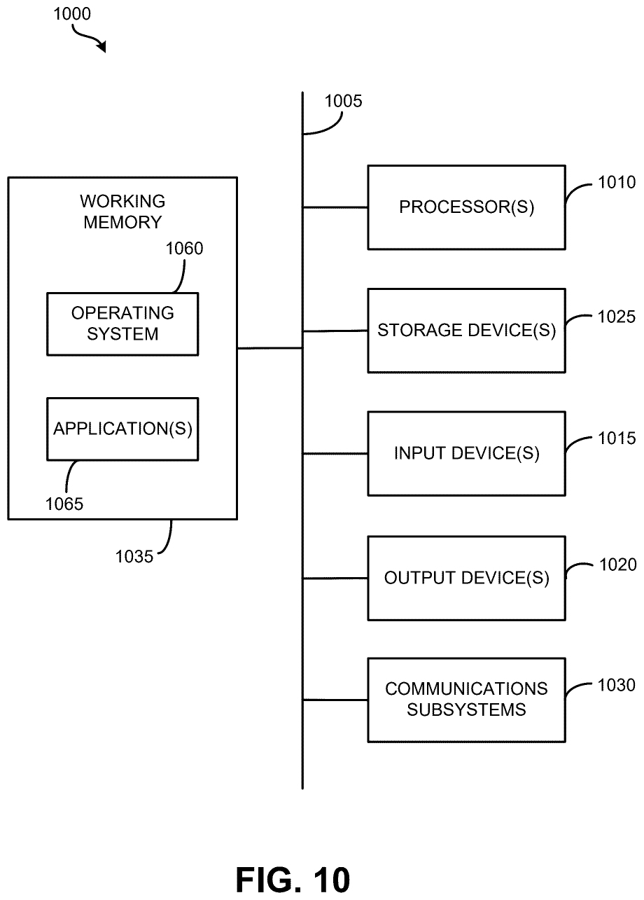

The CBRS systems 100, 300, 500 and any components thereof, such as the communication system of the incumbent user, the centralized security system, the SAS etc., described above may include a computer system that further includes computer hardware and software that form special-purpose network circuitry to implement various embodiments such as communication, generation and collection of data, analysis, determination, identification, calculation, performing a task, execution of a service or application, and other operations or steps of the methods or processes described herein. FIG. 10 is a schematic diagram illustrating an example of computer system 1000. The computer system 1000 is a simplified computer system that can be used to implement various embodiments described and illustrated herein. FIG. 10 provides a schematic illustration of one embodiment of a computer system 1000 that can perform some or all of the steps of the methods and workflows provided by various embodiments. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner.

The computer system 1000 is shown including hardware elements that can be electrically coupled via a bus 1005, or may otherwise be in communication, as appropriate. The hardware elements may include one or more processors 1010, including without limitation one or more general-purpose processors and/or one or more special-purpose processors such as digital signal processing chips, graphics acceleration processors, and/or the like; one or more input devices 1015, which can include without limitation a mouse, a keyboard, a camera, and/or the like; and one or more output devices 1020, which can include without limitation a display device, a printer, and/or the like.

The computer system 1000 may further include and/or be in communication with one or more non-transitory storage devices 1025, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 1000 might also include a communications subsystem 1030, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. The communications subsystem 1030 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 1030. In other embodiments, a portable electronic device, e.g., the first electronic device, may be incorporated into the computer system 1000, e.g., an electronic device as an input device 1015. In some embodiments, the computer system 1000 will further include a working memory 1035, which can include a RAM or ROM device, as described above.

The computer system 1000 also can include software elements, shown as being currently located within the working memory 1035, including an operating system 1060, device drivers, executable libraries, and/or other code, such as one or more application programs 1065, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 10, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 1025 described above. In some cases, the storage medium might be incorporated within a computer system, such as computer system 1000. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 1000 and/or might take the form of source and/or installable code, which, upon compilation and/or installation on the computer system 1000 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 1000 to perform methods in accordance with various embodiments of the technology. According to a set of embodiments, some or all of the operations of such methods are performed by the computer system 1000 in response to processor 1010 executing one or more sequences of one or more instructions, which might be incorporated into the operating system 1060 and/or other code, such as an application program 1065, contained in the working memory 1035. Such instructions may be read into the working memory 1035 from another computer-readable medium, such as one or more of the storage device(s) 1025. Merely by way of example, execution of the sequences of instructions contained in the working memory 1035 might cause the processor(s) 1010 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 1000, various computer-readable media might be involved in providing instructions/code to processor(s) 1010 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 1025. Volatile media include, without limitation, dynamic memory, such as the working memory 1035.

Common forms of physical and/or tangible computer-readable media include, for example, a floppy disk, a flexible disk, hard disk, magnetic tape, or any other magnetic medium, a CD-ROM, any other optical medium, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1000.

The communications subsystem 1030 and/or components thereof generally will receive signals, and the bus 1005 then might carry the signals and/or the data, instructions, etc. carried by the signals to the working memory 1035, from which the processor(s) 1010 retrieves and executes the instructions. The instructions received by the working memory 1035 may optionally be stored on a non-transitory storage device 1025 either before or after execution by the processor(s) 1010.

The methods, processes, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a channel” includes a plurality of such “channels,” and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the present disclosure. For example, the above elements may be components of a larger system, wherein other rules may take precedence over or otherwise modify the application of the present disclosure. Also, a number of steps may be undertaken before, during, or after the above elements are considered.

What is claimed is:

1. A centralized security system (CSS) comprising:
one or more processors; and
a computer-readable storage media storing computer-executable instructions, wherein the instructions when executed by the one or more processors cause the CSS to:
receive a plurality of heartbeat messages at a predetermined time interval, wherein the heartbeat messages are transmitted from an incumbent user of a citizens broadband radio service (CBRS) system through a secure connection, the CBRS system comprises a plurality of citizens broadband service devices (CBSDs) located in a neighborhood proximate to a dynamic protection area (DPA), the DPA comprises a plurality of DPA tiles, each one of the heartbeat messages is time stamped and includes DPA data and radar activity data, the DPA data indicates the DPA tile in which the incumbent user is located, and the radar activity data indicates a radio channel on which an onboard radar of the incumbent user transmits radar signals;
initiate a fallback sensing protection process in response to a determination that the incumbent user is disconnected from the CSS, the fallback sensing protection process comprising:
identifying one or more CBSDs associated with the DPA, based on the latest heartbeat message received in the CSS;
causing each CBSD to continuously detect RADAR signals on an authorized radio channel of the CBSD;
generating a move list indicating the CBSDs determined to interfere with the detected RADAR signals on the authorized channel; and
transmitting the move list to a spectrum access system (SAS and instructing the SAS to cause the CBSDs to prevent interference with the incumbent user on the authorized channel according to the move list.

2. The CSS of claim 1, wherein the secure connection is a SATCOM link.

3. The CSS of claim 1, wherein the incumbent user is determined to be disconnected from the CSS when the CSS fails to receive a heartbeat message after a predetermined time duration has elapsed since the latest heartbeat message.

4. The CSS of claim 1, wherein the instructions when executed by the one or more processors further cause the CSS to:
cease the fallback sensing protection process in response to a determination that the incumbent user resumes connectivity to the CSS.

5. The CSS of claim 4, wherein the instructions when executed by the one or more processors further cause the CSS to:
identify a region in the neighborhood, based on a predetermined mapping rule specifying a correlation between the region and the DPA tile indicated in the heartbeat message;
identify one or more CBSDs located in the region and authorized to operate on the channel indicated in the heartbeat message;
generate a new move list, the new move list indicating the one or more CBSDs; and
transmit the new move list to the SAS to cause the one or more CBSDs to prevent interference with the incumbent user on the channel indicated in the heartbeat message, according to the new move list.

6. The CSS of claim 1, wherein the instructions when executed by the one or more processors cause the CSS to:
determine that a total transmission power of each CBSD of the move list exceeds a predetermined threshold on the authorized channel, based on the detected RADAR signals.

7. The CSS of claim 1, wherein the instructions when executed by the one or more processors cause the CSS to:
determine that an aggregate interference power spectral density of each one of the one or more CBSDs on the radio channel exceeds a predetermined threshold, based on the detected RADAR signals.

8. The CSS of claim 1, wherein the SAS is further instructed by the CSS to terminate transmission of signals on the authorized radio channel by secondary users associated with the one or more CBSDs.

9. The CSS of claim 1, wherein the SAS is further instructed by the CSS to reject a request for transmission of signals on the authorized radio channel by a secondary user associated with the one or more CBSDs.

10. The CSS of claim 1, wherein each one of the DPA tiles has an irregular dimension that is neither square nor rectangular.

11. The CSS of claim 5, wherein the radar activity data further indicates a current operating status of the onboard radar, a transmission power, a pulse repetition frequency, and pulse width of the radar signals.

12. The CSS of claim 11, wherein the instructions when executed by the one or more processors cause the CSS to:
determine that a total transmission power of each CBSD of the new move list exceeds a predetermined threshold on the channel, based on the radar activity data.

13. The CSS of claim 11, wherein the instructions when executed by the one or more processors cause the CSS to:
determine that an aggregate interference power spectral density of each CBSD of the new move list exceeds a predetermined threshold on the channel, based on the radar activity data.

14. The CSS of claim 1, wherein each one of the DPA tiles has an irregular shape that is neither square nor rectangular.

15. A method for preventing interference with an incumbent user associated with a CBRS system comprising a plurality of CBSDs located in a neighborhood proximate to a DPA that comprises a plurality of DPA tiles, wherein the method comprises:
generating, by the incumbent user, a plurality of heartbeat messages at a predetermined time interval, wherein each one of the heartbeat messages is timestamped and includes DPA data and radar activity data, the DPA data indicates the DPA tile corresponding to a current location of incumbent user, and the radar activity data indicates a radio channel on which an onboard radar of the incumbent user transmits radar signals; and
transmitting the plurality of heartbeat messages to a CSS via a secure connection;
initiating, by the CSS, a fallback sensing protection process in response to a determination that the incumbent user is disconnected from the CSS, the fallback sensing protection process comprising:
identifying one or more CBSDs in the DPA, based on the latest heartbeat message received in the CSS;
causing each one of the one or more CBSDs to continuously detect radar signals on an authorized radio channel of the CBSD;
generating a move list indicating the CBSDs that interfere with the detected radar signals on the authorized channel; and
transmitting the move list to a SAS; and
causing, by the SAS, the CBSDs to prevent interference with the incumbent user on the authorized channel, according to the move list.

16. The method of claim 15, wherein the incumbent user is determined to be disconnected from the CSS when the CSS fails to receive a heartbeat message after a predetermined time duration has elapsed since the latest heartbeat message.

17. The method of claim 16, further comprising:
identifying, by the CSS, a region in the neighborhood, based on a predetermined mapping rule specifying a correlation between the region and the DPA tile indicated in the heartbeat message;
identifying, by the CSS, one or more CBSDs located in the region and authorized to operate on the channel indicated in the heartbeat message;
generating, by the CSS, a new move list, the new move list indicating the one or more CBSDs; and
transmitting, by the CSS, the new move list to the SAS to cause the one or more CBSDs to prevent interference with the incumbent user on the channel indicated in the heartbeat message, according to the new move list.

18. The method of claim 15, further comprising:
determining, by the CSS, that a total transmission power of each CBSD of the move list exceeds a predetermined threshold on the authorized channel, based on the detected RADAR signals.

19. The method of claim 15, further comprising:
determining, by the CSS, an aggregate interference power spectral density of each one of the one or more CBSDs on the radio channel exceeds a predetermined threshold, based on the detected RADAR signals.

20. The method of claim 15, further comprising:
terminating, by the SAS, transmission of signals on the authorized radio channel by secondary users associated with the one or more CBSDs; and
rejecting, by the SAS, a request for transmission of signals on the authorized radio channel by a secondary user associated with the one or more CBSDs.
